(19) United States
(12) Patent Application Publication
(10) Pub. No.: US 2025/0285528 A1
(43) Pub. Date: Sep. 11, 2025

(54) METHOD FOR SEARCHING FOR AN ITEM, COMPUTING DEVICE, INTERNET OF THINGS SYSTEM, DEVICE, AND STORAGE MEDIUM

(71) Applicant: XG TECH PTE. LTD., Singapore (SG)

(72) Inventors: Yuhao DOU, Singapore (SG); Xian YANG, Singapore (SG); Qi XIANG, Singapore (SG)

(73) Assignee: XG TECH PTE. LTD., Singapore (SG)

(21) Appl. No.: 19/215,637

(22) Filed: May 22, 2025

(30) Foreign Application Priority Data
Jul. 31, 2024 (CN) 202411048762.9

(51) Int. Cl. G08B 21/24; G06F 16/2457; G06V 10/40; G06V 10/74

(52) U.S. Cl. CPC G08B 21/24; G06F 16/2457; G06V 10/40; G06V 10/761

(57) ABSTRACT

This disclosure provides a method for searching for an item, a computing device, an Internet of Things system, a device, and a storage medium. First item information and first sensor information corresponding to a first event are determined through an item query system. The first sensor information includes sensor information of a first sensor, which includes a sensor corresponding to at least one registered place. The registered place is a place registered in the item query system. After that, a first image acquired by the first sensor is obtained. Further, search for the first item is performed based on the first item information and the first image, to obtain a first search result. In this way, item search effects can be improved.

### RELATED APPLICATION INFORMATION

This application claims priority to and the benefit of Chinese Patent Application No. CN202411048762.9 filed on Jul. 31, 2024, incorporated herein by reference.

### TECHNICAL FIELD

This disclosure relates to artificial intelligence technologies and communication technologies, and in particular, to a method for searching for an item, a computing device, an Internet of Things system, a device, and a storage medium.

### BACKGROUND

In daily scenarios, it is common for users to leave items in daily activity places. For example, when on a business trip or at work, the user may leave a wallet, a key, or other items in a corner of a house; or when driving home from work, the user may leave an earphone, a computer, or other items in a vehicle.

In related technologies, a tracker (tag) with a built-in communication unit such as a Bluetooth chip or a global navigation satellite system (GNSS) may be mounted on each item, so as to find the item by locating the tracker. In this implementation scheme, it is needed to mount a tracker for each item and firmly bind the tracker to the item, being costly and infeasible for some items. In addition, a battery level of the tracker needs to be relied on. Thus, item search is limited.

### SUMMARY

To solve the foregoing technical problem, embodiments of this disclosure provide a method for searching for an item, a computing device, an Internet of Things system, a device, and a storage medium, to improve item search effects.

According to an aspect of this disclosure, a method for searching for an item is provided, wherein the method is applied to an item query system, and includes:
determining first item information and first sensor information corresponding to a first event, where the first sensor information includes sensor information of a first sensor, the first sensor includes a sensor corresponding to at least one registered place, and each registered place of the at least one registered place is a place registered in the item query system;
obtaining a first image acquired by the first sensor; and
searching for a first item based on the first item information and the first image, to obtain a first search result.

According to another aspect of this disclosure, a computing device is provided, wherein the computing device is applied to an item query system, and includes:
a first determining module, configured to determine first item information and first sensor information corresponding to a first event, where the first sensor information includes sensor information of a first sensor, the first sensor includes a sensor corresponding to at least one registered place, and each registered place of the at least one registered place is a place registered in the item query system;
a first obtaining module, configured to obtain a first image acquired by the first sensor; and
an item search module, configured to search for a first item based on the first item information and the first image, to obtain a first search result.

According to still another aspect of this disclosure, an Internet of Things system is provided, and includes at least one sensor and at least one end-side device, where the at least one sensor is deployed in at least one place corresponding to the Internet of Things system; a first end-side device of the at least one end-side device includes a computing unit; a second end-side device of the at least one end-side device includes an information input unit; a third end-side device of the at least one end-side device includes an information output unit; each of the first end-side device, the second end-side device, and the third end-side device includes one or more terminal devices; each sensor of the at least one sensor and each terminal device of the one or more terminal devices include respective communication units; the at least one sensor is in communication connection with the first end-side device through the respective communication units; and other terminal devices in the at least one end-side device other than that in the first end-side device are in communication connection with the first end-side device through the respective communication units.

According to yet another aspect of embodiments of this disclosure, an electronic device is provided, and includes:
a processor; and
a memory, configured to store processor-executable instructions;
wherein the processor is configured to read the executable instructions from the memory, and execute the instructions to implement the method for searching for an item according to any one of the embodiments herein.

According to still yet another aspect of embodiments of this disclosure, a computer readable storage medium is provided. The storage medium stores a computer program. When executed, the computer program implements the method for searching for an item according to any one of the embodiments of this disclosure.

According to a further aspect of embodiments of this disclosure, a computer program product is provided. When instructions in the computer program product are executed by a processor, the method for searching for an item according to any one of the embodiments herein is implemented.

According to the embodiments of this disclosure, a technical solution for searching for an item based on visual technologies is provided. An item query system determines first item information and first sensor information corresponding to a first event. The first sensor information includes sensor information of a first sensor corresponding to at least one registered place. A registered place herein is a place registered in the item query system. After that, the item query system obtains a first image acquired by the first sensor. Further, the item query system searches for a first item based on the first item information and the first image, to obtain a first search result. In this way, item search is implemented. With the technical solution for searching for an item in the embodiments of this disclosure, it is not required to install an additional electronic tool, such as a tracker, on the item, or to secure the electronic tool to the item, saving costs required therefor. The technical solution is applicable to search for any item, with strong scalability and convenient operation. Moreover, the technical solution is not limited by a battery level of the electronic tool, avoiding limitations thereof on item search, enabling effective item search, thereby effectively improving item search effects.

A technical solution of the present invention is further described below in detail with reference to the accompanying drawings and the embodiments.

### BRIEF DESCRIPTION OF DRAWINGS

FIG. 1 is a schematic diagram of a structure of an Internet of Things system according to an illustrative embodiment of this disclosure;

FIG. 2 is an illustrative diagram of an item query system according to an embodiment of this disclosure;

FIG. 3 is a schematic flowchart of a method for searching for an item according to an illustrative embodiment of this disclosure;

FIG. 4 is an illustrative schematic flowchart of determining first item information and first sensor information in a method for searching for an item according to another illustrative embodiment of this disclosure;

FIG. 5 is an illustrative schematic flowchart of searching for a first item in a method for searching for an item according to another illustrative embodiment of this disclosure;

FIG. 6 is an illustrative schematic flowchart of place registration according to an embodiment of this disclosure;

FIG. 7 is an illustrative schematic flowchart of item registration according to an embodiment of this disclosure;

FIG. 8 is a flowchart of applying a method for searching for an item according to another illustrative embodiment of this disclosure;

FIG. 9 is an schematic flowchart of a method for searching for an item according to another illustrative embodiment of this disclosure;

FIG. 10 is a flowchart of applying a method for searching for an item according to still another illustrative embodiment of this disclosure;

FIG. 11 is an illustrative schematic flowchart of determining first item information and first sensor information in a method for searching for an item according to still another illustrative embodiment of this disclosure;

FIG. 12 is an illustrative schematic flowchart of searching for a first item in a method for searching for an item according to still another illustrative embodiment of this disclosure;

FIG. 13 is another illustrative schematic flowchart of searching for a first item in a method for searching for an item according to still another illustrative embodiment of this disclosure;

FIG. 14 is still another illustrative schematic flowchart of searching for a first item in a method for searching for an item according to yet another illustrative embodiment of this disclosure;

FIG. 15 is a flowchart of applying a method for searching for an item according to yet another illustrative embodiment of this disclosure;

FIG. 16 is yet another illustrative schematic flowchart of searching for a first item in a method for searching for an item according to still yet another illustrative embodiment of this disclosure;

FIG. 17 is still yet another illustrative schematic flowchart of searching for a first item in a method for searching for an item according to a further illustrative embodiment of this disclosure;

FIG. 18 is an illustrative schematic flowchart of determining first item information and first sensor information in a method for searching for an item according to yet another illustrative embodiment of this disclosure;

FIG. 19 is a schematic diagram of a structure of a computing device according to an illustrative embodiment of this disclosure;

FIG. 20 is a schematic diagram of a structure of a computing device according to another illustrative embodiment of this disclosure;

FIG. 21 is a schematic diagram of a structure of a computing device according to still another illustrative embodiment of this disclosure;

FIG. 22 is a schematic diagram of a structure of a computing device according to yet another illustrative embodiment of this disclosure;

FIG. 23 is a schematic diagram of a structure of a computing device according to still yet another illustrative embodiment of this disclosure; and

FIG. 24 is a diagram of a structure of an electronic device according to an illustrative embodiment of this disclosure.

### DETAILED DESCRIPTION OF THE EMBODIMENTS

To explain this disclosure, illustrative embodiments of this disclosure are described below in detail with reference to accompanying drawings. Obviously, the embodiments described are merely some, rather than all of embodiments of this disclosure. It should be understood that this disclosure is not limited by the illustrative embodiments described herein.

It should be noted that unless otherwise specified, the scope of this disclosure is not limited by relative arrangement, numeric expressions, and numerical values of components and steps described in these embodiments.

Overview of this Disclosure

In daily scenarios, it is common for users to leave items in daily activity places. For example, in some scenarios, when on a business trip or at work, the user may leave a wallet, a key, or other items in a corner of a house; or in some other scenarios, when driving home from work, the user may leave an earphone, a computer, or other items in a vehicle.

In a related technology, a tracker with a built-in communication unit such as a Bluetooth chip or a GNSS may be mounted on each item, so as to find the item by locating the tracker. If the item is nearby, the tracker may be controlled to play sound. In this implementation scheme, higher costs are resulted in because it is needed to mount a tracker for each item, while the tracker is costly. Moreover, it is needed to firmly bind the tracker to the item, being complex in mounting and infeasible for some items. In addition, a battery level of the tracker needs to be relied on, and a location of the corresponding item cannot be found when a battery of the tracker is depleted. Thus, item search is limited.

### Illustrative System

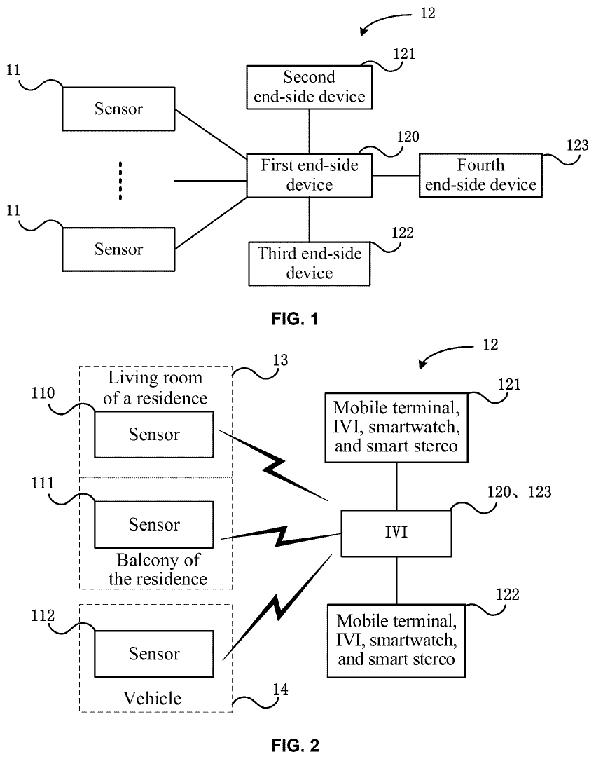

FIG. 1 is a schematic diagram of a structure of an Internet of Things system according to an illustrative embodiment of this disclosure. As shown in FIG. 1, the Internet of Things system in this embodiment of this disclosure includes at least one sensor 11 and at least one end-side device 12.

The at least one sensor 11 is deployed in at least one place corresponding to the Internet of Things system. In specific applications, the sensor deployed in each place may be an individually deployed sensor or may be a sensor on an existing device in each place. For example, when the place corresponding to the Internet of Things system is a manned mobile device such as a vehicle, a ship, aviation equipment (such as an airplane or an aircraft), or an intelligent terminal, the sensor deployed in the mobile device may be a camera of a driver monitoring system (DMS), a camera of an occupancy monitoring system (OMS), or a camera of an in-cabin monitoring system (IMS) in the mobile device. Sources and deployment modes of sensors are not limited in this embodiment of this disclosure.

A first end-side device 120 in the at least one end-side device 12 includes a computing unit for providing computing power. In some optional examples, the computing unit may have certain computing power, and may process at least one type of information, such as images, videos, audio, and text, which is not limited in embodiments of this disclosure. With rapid development of artificial intelligence (AI) technologies and continuous improvement in computing power of AI chips, a mobile terminal or an in-vehicle infotainment (IVI) system provided with the AI chip may provide powerful AI computing power, so as to be used as the first end-side device 120, which may be used as an end-side AI device to serve as an AI computing center.

A second end-side device 121 in the at least one end-side device 12 includes an information input unit for implementing an information input function. In some optional examples, the information input unit may implement various forms of information input functions according to at least one manner of acquiring images, videos, and audio, and receiving user input text, which is not limited in embodiments of this disclosure.

A third end-side device 122 in the at least one end-side device 12 includes an information output unit for implementing an information output function. In some optional examples, the information output unit may output at least one type of information, such as images, videos, audio, sound, text, dynamic signals (such as vibrations), and light signals.

Each of the first end-side device 120, the second end-side device 121, and the third end-side device 122 may include one or more terminal devices. FIG. 1 merely illustrates a case in which each of the first end-side device 120, the second end-side device 121, and the third end-side device 122 includes one terminal device. For a case where each of the first end-side device 120, the second end-side device 121, and the third end-side device 122 includes a plurality of terminal devices, reference may be made thereto for implementation.

Each of the at least one sensor 11 and each of the at least one end-side device 12 respectively include a communication unit. The at least one sensor 11 is in communication connection to the first end-side device 120 through the communication unit; and other terminal devices, except the first end-side device 120, in the at least one end-side device 12 are in communication connection to the first end-side device 120 through the communication unit. In some optional examples, communication units in various sensors and terminal devices may communicate through at least one of various communication networks such as a mobile communication network (such as 5G or 4G) and a wireless local area network (wireless fidelity, WiFi).

Based on this embodiment, an Internet of Things system based on visual technologies is provided. The Internet of Things system may be obtained by interconnected sensors and terminal devices that are at end sides, and includes a sensor deployed in a corresponding place, and a terminal device with computing power, an information input function, and an information output function, thus being capable of acquiring, calculating, and processing scenario data for various places within a scope of the Internet of Things system and circulating the scenario data within the Internet of Things system and performing information exchange between users. There is no need to mount an additional electronic tool such as a tracker for an item, without being limited by a battery level of the electronic tool. In other words, application processing required by the user may be implemented within a range of the corresponding place, such as target query based on the scenario data. Regarding the Internet of Things system, more end-side devices (including sensors and terminal devices) may be added or accessed end-side devices may be changed according to requirements, with strong scalability and easy operation. The Internet of Things system includes terminal devices with computing power, which may serve as computing centers. Idle end-side computing resources are fully utilized to provide the computing power required by the Internet of Things system, without providing additional computing resources, thereby saving costs.

Optionally, in another illustrative embodiment of the Internet of Things system in this disclosure, a fourth end-side device 123 in the at least one end-side device 12 includes an information storage unit for implementing a storage function. The fourth end-side device 123 may include one or more terminal devices.

In some possible implementations, terminal devices included in the first end-side device 120, the second end-side device 121, the third end-side device 122, and the fourth end-side device 123 may be same, different, or partially the same. For example, a mobile terminal that includes a computing unit, an input unit, an output unit, and a storage unit, a personal computer (PC), and IVI may serve as the first end-side device 120, the second end-side device 121, the third end-side device 122, and the fourth end-side device 123. A smartwatch that includes both an input unit and an output unit may serve as both the second end-side device 121 and the third end-side device 122.

In some possible implementations, the at least one sensor 11 in the Internet of Things system in this embodiment of this disclosure may include at least one type of the following sensors: a visual sensor (such as a camera), a laser radar, and a laser rangefinder. The camera may be a monocular camera, a binocular camera, or a multocular camera. Types of the sensors are not limited in this embodiment of this disclosure. When the sensor is a visual sensor, image acquisition may be directly performed for the corresponding place. When the sensor is a laser radar, point cloud data may be collected for the corresponding place, and a three-dimensional scenario may be obtained by performing three-dimensional reconstruction based on the collected point cloud data. When the sensor is a laser rangefinder, distance measurement may be performed for the corresponding place, to generate a depth image based on the distance measurement data. In this embodiment of this disclosure, description is made using the visual sensor and data images acquired thereby as an example. For other types of sensors and data acquired thereby, reference may be made thereto for implementation, and details are not described in this embodiment of this disclosure.

In some possible implementations, the at least one end-side device 12 in the Internet of Things system in this embodiment of this disclosure may include at least one type of the following terminal devices: PCs, mobile terminals, handheld or laptop devices, wearable devices (such as smartwatches, smart bracelets, and augmented reality (AR) glasses), smart household appliances (such as smart stereos, smart televisions, and smart alarms), and IVI (such as in-vehicle stereos and in-vehicle displays). Types of the end-side devices are not limited in this embodiment of this disclosure.

In some possible implementations, the at least one end-side device 12 in the Internet of Things system in this embodiment of this disclosure includes a terminal device for which the user or a family of the user has usage permission. The at least one place corresponding to the Internet of Things system includes at least one of at least one mobile device for which the user or the family of the user has usage permission and at least one fixed place.

In some optional examples, the mobile device may include but is not limited to at least one of manned devices, such as a vehicle, a ship, aviation equipment (such as an airplane or an aircraft), and an intelligent terminal. There may be one or more mobile devices in the at least one mobile device. When the at least one mobile device includes a plurality of mobile devices, types of the plurality of mobile devices may be same, different, or partially the same. For example, the at least one mobile device may include 2 vehicles, 1 airplane, and 2 ships. Types and quantities of the mobile devices included in the at least one place corresponding to the Internet of Things system are not limited in this embodiment of this disclosure.

In some optional examples, the fixed place may include but is not limited to at least one of a residence, a business activity venue, an office, an entertainment place, a fitness center, and other places. There may be one or more fixed places in the at least one fixed place. When the at least one fixed place includes a plurality of fixed places, types of the plurality of fixed places may be same, different, or partially the same. For example, the at least one fixed place may include 2 residences and 1 office. Types and quantities of the fixed places included in the at least one place corresponding to the Internet of Things system are not limited in this embodiment of this disclosure.

With rapid development of AI technologies and continuous improvement in computing power of AI chips, the mobile terminal, the IVI, the PC, and many other end-side devices of the user are provided with AI chips, which can provide powerful AI computing power, and can be used as first end-side devices to serve as AI computing centers. Based on this embodiment, the Internet of Things system is constructed by end-side devices for which the user or the family of the user has usage permission, and sensors deployed in a place for which the user or the family has usage permission. Thus, an Internet of Things system within a family domain is formed, which can implement data acquisition, AI computing processing, information input and output, and data interconnection within the system for a scenario taking the family as a center. Thus, locating of any item based on an AI algorithm can be implemented within the scope of the Internet of Things system, and the Internet of Things system may also be referred to as a family-based Internet of Things system or universal locating system. In the family-based universal locating system, the mobile terminal, the IVI, the PC, and many other end-side devices of the user are used to provide the AI computing power, and idle AI computing resources are fully utilized to create a family AI computing center to provide the computing power required by the Internet of Things system, without providing additional computing resources, thereby saving costs.

In some possible applications, the Internet of Things system in this embodiment of this disclosure may be configured as an item query system, so as to search for items in at least one place corresponding to the item query system. In this application scenario, one terminal device in the first end-side device 120 is configured as a computing device for implementing the method for searching for an item in various embodiments of this disclosure. In this application scenario, the computing device may also be referred to as a device for searching for an item.

When the Internet of Things system in this embodiment of this disclosure is configured as an item query system, the storage unit in the fourth end-side device 123 may be configured to store at least one of sensor acquired data (such as images acquired by the at least one sensor 11) involved in the item query system, a registered place information table, a registered item information table, alarm-triggering item information, a log file, a registration user information table, usage permission information of the item query system, and other relevant information. The registration user information table includes user registration information of at least one user registered in the item query system. A registered place information table of any registration user (referred to as a first user below) includes registered place information of at least one registered place registered by the first user in the item query system, and the registered place information of each registered place includes place information of each registered place and sensor information corresponding to each registered place. The registered item information table of the first user includes item registration information of at least one registered item registered by the user in the item query system, and the item registration information of each registered item includes item information and a first place list of each registered item. The item information of each registered item includes at least one of an image and item description information of each registered item. When the item information of each registered item includes the image, the item registration information of each registered item also includes feature information obtained by performing feature extraction on the image. The first place list of each registered item includes place information of a second place where each registered item is allowed to be left behind. Alarm item information corresponding to any place is information about an alarm-triggering item that is registered by the corresponding user and is not allowed to be left behind in the corresponding registered place.

In specific implementation, when the fourth end-side device 123 includes a plurality of terminal devices, the foregoing relevant information may be stored in one of the terminal devices included in the fourth end-side device 123 according to user settings, or may be dispersedly stored in all the terminal devices included in the fourth end-side device 123 in a preset manner. For example, in some optional examples, the foregoing relevant information may be dispersedly stored in all the terminal devices included in the fourth end-side device 123 according to types. Alternatively, in some other optional examples, various parts of the foregoing relevant information may be dispersedly stored, in all the terminal devices included in the fourth end-side device 123 according to access efficiency. For example, images acquired by sensors deployed in various places are stored in fourth end-side devices located in all places, and other information in the foregoing relevant information is stored in other fourth end-side devices. Alternatively, in still some other optional examples, the foregoing relevant information may be dispersedly stored in all the terminal devices included in the fourth end-side device 123 by means of combining types and access efficiency. Alternatively, in still some other optional examples, the foregoing relevant information may be dispersedly stored in all the terminal devices included in the fourth end-side device 123 by means of combining types and access efficiency. Alternatively, in yet some other optional examples, the foregoing relevant information may be dispersedly stored in all the terminal devices included in the fourth end-side device 123 according to user settings. A specific manner of storing information in the fourth end-side device is not limited in this embodiment of this disclosure.

In specific applications, storage data in the fourth end-side device 123 may be cleared in a preset manner to improve utilization of storage resources of the fourth end-side device 123. For example, in some optional examples, sensor acquired data with storage duration greater than preset duration (such as 7 days) in the fourth end-side device 123 may be periodically deleted to free up storage space. In some other optional examples, when information stored in the fourth end-side device 123 exceeds preset storage capacity (such as 100 G), the sensor acquired data with earlier storage time in the fourth end-side device 123 may be sequentially deleted according to the storage time, so as to limit the information stored in the fourth end-side device 123 within a preset storage capacity range, thereby avoiding a problem that new sensor acquired data cannot be stored due to insufficient capacity of the end-side device. A specific manner of clearing the storage data in the fourth end-side device 123 is not limited in this embodiment of this disclosure.

In some possible implementations, the Internet of Things system may be constructed and configured as an item query system by a user (referred to as a second user below). The second user and the first user may be a same user or different users. The second user or a family of the second user has usage permission for a plurality of terminal devices, some of which include computing units. All the terminal devices include information input units, information output unit, and storage units. A system menu of the terminal device including the computing unit may include menu items for constructing the Internet of Things system and configuring the Internet of Things system as an item query system, and/or an application (APP) for constructing the Internet of Things system and configuring the same as an item query system may be installed. The second user may choose to construct and configure the relevant information of the item query system through the system menu or the APP. A specific implementation manner for constructing and configuring the relevant information of the item query system is not limited in this embodiment of this disclosure.

In an optional example, after the second user logs in to a plurality of terminal devices with a user account, the plurality of terminal devices may be associated based on that user account. Alternatively, the second user may also associate the plurality of terminal devices by means of near field communication (such as Bluetooth communication). An association manner for a plurality of terminal devices of a same user is not limited in this embodiment of this disclosure. The second user may obtain device information of the plurality of terminal devices associated with the second user through the system menu or the APP, and may set the plurality of terminal devices, such as selecting which terminal devices to construct the item query system, configuring or specifying which terminal device including the computing unit as the computing device to implement the method for searching for an item in the embodiments of this disclosure, specifying which terminal device including the storage unit as a storage device for the relevant information of the item query system, and setting the usage permission information of the item query system (including a user account with usage permission), so as to complete the construction of the Internet of Things system and information configuration of the item query system.

After setting the usage permission information for the item query system, the second user may perform user registration in the item query system to add user registration information of the second user into the registration user information table of the item query system; perform place registration to add registered place information of the registered place into the registered place information table of the item query system; and perform item registration to add item registration information of the registered item into the registered item information table of the item query system.

After setting the usage permission information for the item query system, the second user may also share the usage permission information with a family member thereof (such as the first user). The family member performs user registration in the item query system based on the usage permission information, to add user registration information of the first user into the registration user information table of the item query system; performs place registration to add registered place information of the registered place into the registered place information table of the item query system; and performs item registration to add item registration information of the registered item into the registered item information table of the item query system.

After completing user registration in the item query system, the first user or the second user may set alarm setting information, such as alarm devices and alarm forms (such as sound, text, light signals, and vibration), so that an alarm message may be sent to the first user or the second user through the alarm setting information when the item query system detects that the registered item of the first user or the second user is lost. Taking the second user as an example, in some optional examples, when receiving an alarm setting request sent from the second user, the item query system may generate the alarm setting information in the user registration information of the second user based on the alarm setting request. The alarm setting information includes alarm devices and alarm forms, where the alarm devices include one or more terminal devices, in the item query system, for which the second user of the family of the second user has usage permission. When the second user does not set the alarm setting information, a default alarm mode set in the item query system may be used as the alarm setting information of the second user, which is not limited in embodiments of this disclosure.

In related technologies, when a tracker is mounted to search for the item, there is a risk of user privacy disclosure because location data of the tracker may be uploaded to a cloud network of a service provider. The item query system implemented based on the Internet of Things system in this embodiment is interconnected to sensors through the terminal device for which the user or the family of the user has usage permission. Thus, an item query system within the family domain is formed. This item query system may search for items using visual technologies, without mounting an additional electronic tool such as a tracker for the item, or firmly binding the electronic tool to the item, thus saving required costs, being applicable to search for any item, having strong scalability, and being convenient for operation. Moreover, the item query system is not limited by a battery level of the electronic tool, thus avoiding limitations on item search and enabling effective item search, thereby effectively improving item search effects. In addition, one of the terminal devices in the item query system is used as the computing device to provide computing resources required for item search, and required computing models are all deployed in a private device within the family domain. Configuration information of the entire item query system and data involved in an item query process only circulate between private terminal devices within the family domain, and are not required to be uploaded to cloud. In this case, compared to the related technologies, privacy security of the user is effectively ensured.

FIG. 2 is an illustrative diagram of an item query system according to an embodiment of this disclosure. As shown in FIG. 2, in this example, after an Internet of Things system is configured as an item query system, registered places of a user (referred to as a first user below) in the item query system include a residence 13 and a vehicle 14. Visual sensors 110 and 111 in at least one sensor 11 are deployed in a living room and a balcony of the residence 13, respectively. A visual sensor 112 in the at least one sensor 11 is deployed in a cockpit of the vehicle 14. At least one end-side device 12 includes a PC, a mobile terminal, IVI, a smartwatch, and a smart stereo for which the first user or a family of the first user has usage permission. Each of the PC, the mobile terminal, and the IVI includes a computing unit and a storage unit, which may be used as a first end-side device 120 and a fourth end-side device 123. The IVI is configured as a computing device, and is designated as a storage device for relevant information involved in the item query system. Each of the PC, the mobile terminal, the IVI, the smartwatch, and the smart stereo includes an information input unit and an information output unit, which may be used as a second end-side device 121 and a third end-side device 122. Sensors and terminal devices in the item query system respectively include a communication unit, and support communication with each other in 5G, WiFi, and other manners.

In an application example based on the item query system shown in FIG. 2, an alarm may be given for a left-behind registered item. For example, when the visual sensor 112 in the cabin of the vehicle 14 detects that the first user leaves the vehicle 14, a notification message indicating that the first user has left the vehicle 14 is sent to the IVI. The IVI obtains alarm-triggering item information corresponding to the vehicle 14, and obtains an image acquired by the visual sensor 112. Assuming that an alarm-triggering item indicated by the alarm-triggering item information is a headphone, search for the headphone may be performed based on the alarm-triggering item information corresponding to the vehicle 14 and the image acquired by the visual sensor 112. If an image corresponding to the headphone is found in the image acquired by the visual sensor 112, it is indicated that the headphone is left behind in the vehicle 14 after the first user got off the vehicle. In this case, a wearable device (the mobile terminal or the smartwatch) of the first user is instructed to send an alarm message to the first user for warning in a form of voice, text, or pictures.

In another application example based on the item query system shown in FIG. 2, search for an item may be implemented. The first user initiates an item search request in a form of voice, text, or pictures through a human-computer interaction interface (which serve as an information input unit) in the mobile terminal. The request carries item description information, such as “Please help me find a blue staff badge”. The mobile terminal forwards the item search request to the IVI. The IVI calls all visual sensors in the item query system to perform image acquisition, and obtains three images; and traverses the three images sequentially based on first item description information, to determine whether an image corresponding to the blue staff badge is included in the three images. If none of the three images includes the image corresponding to the blue staff badge, a null value or a search result message indicating that the blue staff badge is not found may be returned. If any one (which is assumed to an image acquired by the visual sensor 110) of the three images includes the image corresponding to the blue staff badge, a search result message may be returned in a form of text, voice, or images through the human-computer interaction interface (which serve as an information output unit) in the mobile terminal. The search result message includes an image (acquired by the visual sensor 110) for which an item object bounding box and/or a location coordinate of the blue staff badge is labeled, and location description information in a form of text or voice (for example, the blue staff badge is on a sofa in the living room).

In another application example based on the item query system shown in FIG. 2, tracking of the registered item may be implemented. After the item is registered in the item query system, the IVI obtains the item registration information of the registered item, and calls all visual sensors in the item query system to perform image acquisition and obtain three images. Based on the item registration information of the registered item and the three images, the IVI determines a target registered place where the registered item is currently located, and then calls the visual sensor corresponding to the target registered place to perform image acquisition regularly (for example, once every 2 minutes) and perform object detection and location tracing for the registered item, where a traced location is recorded. If the location of the registered item changes, frequency of image acquisition and object detection (for example, once every 20 seconds) is increased, a sequence of the acquired images is analyze using an analysis model, and an analysis result is stored in the log file of the item query system. If the registered item later disappears from sight, a possible location or whereabouts (such as being put in a bag) of the registered item may be determined based on the analysis result, so as to improve possibility of finding the registered item.

### Illustrative Method

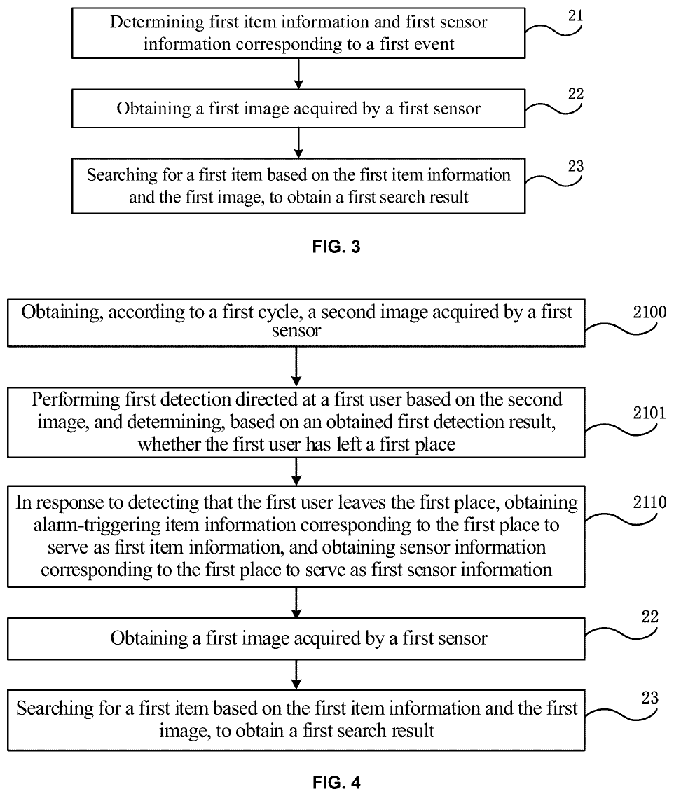

FIG. 3 is a schematic flowchart of a method for searching for an item according to an illustrative embodiment of this disclosure. The method for searching for an item in this illustrative embodiment of this disclosure applies to an item query system, and may be specifically implemented through an electronic device (such as a computing device with computing power or an end-side device configured as a computing device) in an application system. As shown in FIG. 3, the method for searching for an item in this embodiment includes the following steps.

Step 21: Determining first item information and first sensor information corresponding to a first event.

The first sensor information includes sensor information of a first sensor, the first sensor includes a sensor corresponding to at least one registered place, and the registered place is a place registered in the item query system. The first sensor may include one or more sensors. Quantities of sensors corresponding to different registered places in the at least one registered place may be same or different, and each registered place may correspond to one sensor or more sensors, which is not limited in embodiments of this disclosure.

Each piece of sensor information uniquely identifies one sensor in the item query system. The sensor information may include at least one of information of the sensor: a name, a number, a corresponding place, and a location in the corresponding place. For example, in an optional example, a piece of sensor information is Camera-0098-Residence 1-Living Room 002, which indicates that an identified sensor is a camera with a number of 0098. This camera is deployed in a living room of the residence 1, and is a camera 002 in the living room of the residence 1.

The first event in this embodiment of this disclosure specifically refers to an event that can trigger search for an item. The first event may be set as needed, and may be updated as required. For example, in some possible implementations, the first event may include but is not limited to at least one of: the first user leaves a first place, an item search request sent by the first user is received, and it is detected that item registration information is added to the item query system, which is not limited in embodiments of this disclosure. The first user may be any user registered in the item query system, which is not limited in this embodiment of this disclosure.

Step 22: Obtaining a first image acquired by a first sensor.

When the first sensor includes one sensor, the first image may include one or more images. When the first sensor includes a plurality of sensors, the first image may include one or more images acquired by each sensor in the first sensor, which is not limited in embodiments of this disclosure.

Step 23: Searching for a first item based on the first item information and the first image, to obtain a first search result.

Based on this embodiment of this disclosure, a technical solution for item search based on visual technologies is provided. The first item information and the first sensor information corresponding to the first event are determined. The first sensor information includes the sensor information of the first sensor corresponding to the at least one registered place. The registered place is a place registered in the item query system. After that, the first image acquired by the first sensor is obtained. Further, search for the first item is performed based on the first item information and the first image, to obtain the first search result. In this way, item search is implemented. In this embodiment, it is not required to mount an additional electronic tool such as a tracker for the item, or firmly bind the electronic tool to the item, thus saving required costs, being applicable to search any item, having strong scalability, and being convenient for operation. Moreover, this embodiment is not limited by a battery level of the electronic tool, thus avoiding limitations on item search and enabling effective item search, thereby effectively improving item search effects.

In some possible implementations, the first event refers to that the first user leaves the first place. FIG. 4 is an illustrative schematic flowchart of determining first item information and first sensor information in a method for searching for an item according to another illustrative embodiment of this disclosure. The another illustrative embodiment of the method for searching for an item is an embodiment corresponding to the event that the first user leaves the first place. As shown in FIG. 4, on the basis of the embodiment shown in FIG. 3, in this embodiment, step 21 may include the following steps.

Step 2110: In response to detecting that the first user leaves the first place, obtaining alarm-triggering item information corresponding to the first place to serve as the first item information, and obtaining sensor information corresponding to the first place to serve as the first sensor information.

The first user in this embodiment may be any user registered in the item query system, which is not limited in this embodiment of this disclosure.

In this embodiment, the first place is one of at least one registered place registered by the first user in the item query system, the alarm-triggering item information includes information about at least one alarm-triggering item, and the alarm-triggering item is an item registered by the first user as not to be left behind in a corresponding registered place.

Through step 2110, when it is detected that the first user leaves the first place, information about the at least one alarm-triggering item registered by the first user as not to be left behind in a first place may be obtained, and the sensor information of the sensor corresponding to the first place (that is, deployed in the first place) may be obtained, so as to obtain images acquired by the sensor corresponding to the first place. Whether the item that is not allowed to be left behind is left behind in the first place is searched in combination with the alarm-triggering item information.

In accordance with the embodiment shown in FIG. 4, in some optional examples, in step 22, the first image already acquired by the first sensor may be obtained, and the first image may include one or more images acquired by each sensor in the first sensor in a most recent acquisition. Alternatively, each sensor in the first sensor may be called to perform image acquisition, and each sensor may acquire one or more images, obtaining the first image.

Based on this embodiment, when the first user leaves the first place, the image acquired by the sensor corresponding to the first place may be obtained to search whether the item that is not allowed to be left behind is left behind in the first place.

In some optional implementations, before step 2110, whether the first user has left the first place may also be determined as follows.

Step 2100: Obtaining, according to a first cycle, a second image acquired by the first sensor.

The second image may include one or more images acquired by each sensor in the first sensor in a most recent acquisition.

When a value of the first cycle is relatively small, it may be detected in a timely manner that the user leaves the first place, but it is required to detect the second image acquired for each first cycle, which consumes relatively more computing resources. When the value of the first cycle is relatively large, relatively less computing resources need to be consumed, but the event that the user leaves the first place may cannot be detected in a timely manner. Therefore, in practical applications, the first user may set the value of the first cycle as needed. For example, the value of the first cycle may be set to 5 minutes or 10 minutes, and may be modified as required. The value and the modification mode of the first cycle are not limited in this embodiment of this disclosure.

Step 2101: Performing first detection directed at the first user based on the second image, and determining, based on an obtained first detection result, whether the first user has left the first place.

If the first detection result indicates that an image of the first user is detected in the second image, it may be determined that the first user is in the first place, that is, the first user has not left the first place. Otherwise, if the first detection result indicates that no image of the first user is detected in the second image, it may be determined that the first user is not in the first place, that is, the first user has left the first place.

Optionally, the first detection for the first user may be face detection or skeleton detection for the first user. In some optional examples, based on a face image (referred to as a registered face image below) and a skeleton image (referred to as a registered skeleton image below) that are provided by the first user when registering in the item query system, the face detection and the skeleton detection for the first user may be performed on the second image. Whether the image of the first user is detected in the second image is determined based on whether there is a corresponding face image, in the second image, with similarity with the registered face image greater than a preset similarity threshold, or whether there is a corresponding skeleton image with similarity with the registered skeleton image greater than the preset similarity threshold. A specific detection manner of the first detection is not limited in this embodiment of this disclosure.

Based on this embodiment, images acquired by various sensors corresponding to the first place may be periodically obtained for detection, so as to determine whether the first user has left the first place. In this way, the event that the first user leaves the first place may be detected in a timely manner.

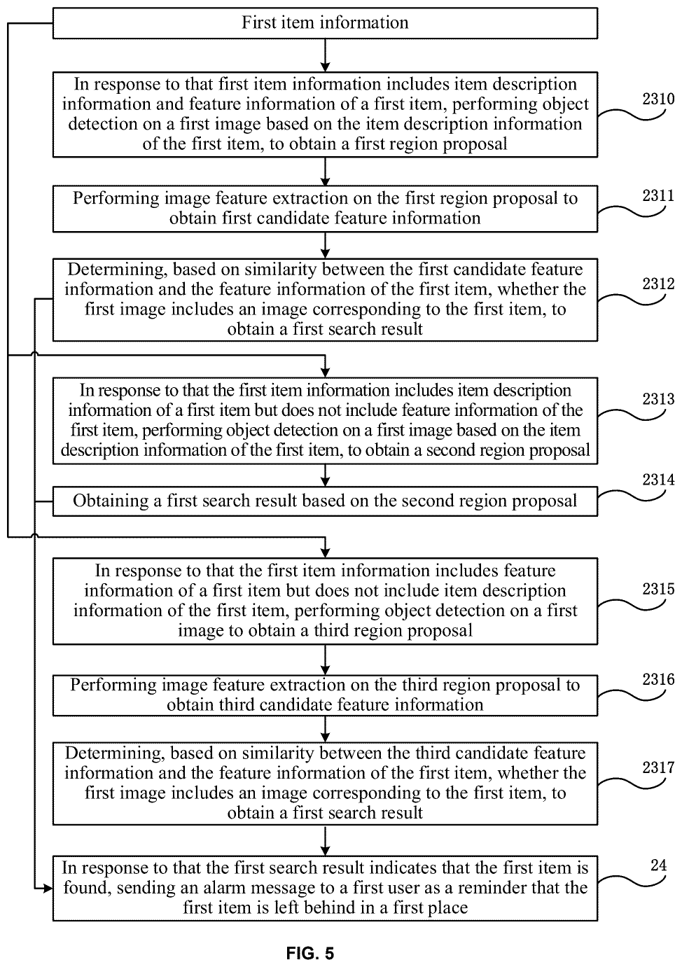

FIG. 5 is an illustrative schematic flowchart of searching for a first item in a method for searching for an item according to another illustrative embodiment of this disclosure. As shown in FIG. 5, on the basis of the embodiment shown in FIG. 3 or FIG. 4, in this embodiment, step 23 may include the following steps.

Step 2310: In response to that the first item information includes item description information and feature information of the first item, performing object detection on the first image based on the item description information of the first item, to obtain a first region proposal (RP).

The first item in this embodiment is an item (such as a handbag) corresponding to the first item information, that is, is the alarm-triggering item corresponding to the first place. The item description information of the first item may include vocabulary used to describe a name, a color, use, and other related information of the first item, such as “a blue staff badge” and “a red wallet”. The feature information of the first item is obtained by performing feature extraction on an image of the first item.

The first region proposal in this embodiment is obtained by performing object detection on the first image based on the item description information of the first item. The first region proposal may include one or more region proposals. If the first region proposal includes a plurality of region proposals, steps 2311 and 2312 are performed for each region proposal included in the first region proposal.

In some possible implementations, in step 2310, an open vocabulary object detection (OVD) algorithm may be used to pre-learn a region-word alignment capability from image-text data, and object detection may be performed on the first image based on the vocabulary in the item description information of the first item, to obtain the first region proposal. The first region proposal may include an entity (that is, a bounding box) corresponding to the region proposal and description in phrases thereof.

Alternatively, in some other possible implementations, in step 2310, a visual grounding algorithm may also be used to perform object detection on the first image based on the item description information of the first item, to obtain the first region proposal. The first region proposal may include an entity (that is, a bounding box) corresponding to the region proposal, and may also optionally include attribute description about the entity (that is, description about content in the bounding box).

Alternatively, in still some other possible implementations, in step 2310, a visual grounding model (VGM) that integrates the OVD algorithm and the visual grounding algorithm may be used to directly circle the first item from the first image based on the first item information, that is, to determine an item object bounding box of the first item from the first image. In specific implementation, the VGM may be implemented using an encoder-decoder structure. Encoders may include a text encoder, an image encoder, and a visual encoder. The text encoder may be used to perform feature extraction on input text (such as the item description information of the first item) to obtain a text feature, the image encoder may be used to perform feature extraction on input feature information (such as the feature information of the first item) to obtain an image feature, and the visual encoder may be used to perform feature extraction on an input image (such as the first image) to obtain a visual feature (such as first candidate feature information). The features extracted by the encoders are output to the decoder, which outputs the item object bounding box of the first item based on the features output by the encoders.

In step 2310, if object detection is performed on the first image and no region proposal is obtained, steps 2311 and 2312 are not performed, and a first search result indicating that the first item is not found is obtained.

Step 2311: Performing image feature extraction on the first region proposal to obtain first candidate feature information.

Step 2312: Determining, based on similarity between the first candidate feature information and the feature information of the first item, whether the first image includes an image corresponding to the first item, to obtain the first search result.

Specifically, when the similarity between the first candidate feature information and the feature information of the first item is greater than a first preset threshold, it may be considered that the first region proposal is similar to the image corresponding to the first item, and it may be determined that the first image includes the image corresponding to the first item. When the similarity between the first candidate feature information and the feature information of the first item is not greater than the first preset threshold, it is considered that the first region proposal is not similar to the image corresponding to the first item, and it is determined that the first image does not include the image corresponding to the first item. The first preset threshold may be determined as needed, and may be updated according to requirements, which is not limited in embodiments of this disclosure.

When the first region proposal includes a plurality of region proposals, if similarity between first candidate feature information corresponding to any region proposal in the first region proposal and the feature information of the first item is greater than the first preset threshold, the first search result indicates that the first item is found. If similarity between first candidate feature information corresponding to all region proposals in the first region proposal and the feature information of the first item is not greater than the first preset threshold, the first search result indicates that the first item is not found.

If the first image includes the image corresponding to the first item, the first search result may include at least one of: the first image for which the item object bounding box (that is, the bounding box included in the first region proposal) and/or a location coordinate of the first item is labeled, and location description information of the first item. If the first image does not include the image corresponding to the first item, the first search result may be a null value.

Optionally, information specifically included in the first item information may be determined before step 2310. When the first item information includes the item description information and the feature information of the first item, if the first region proposal is obtained by performing object detection on the first image based on the item description information of the first item, it may be considered that a suspected object is detected; and then, the feature information of the first item may be compared with features of the first region proposal to further determine whether the suspected object is the first item (such as a handbag). In other words, search for the first item is performed based on both the item description information and the feature information of the first item, to determine whether the first image includes the image corresponding to the first item. Thus, accuracy of searching for the first item may be improved.

Optionally, referring again to FIG. 5, in another illustrative embodiment of the method for searching for an item, step 23 may further include the following steps.

Step 2313: In response to that the first item information includes item description information of the first item but does not include feature information of the first item, performing object detection on the first image based on the item description information of the first item, to obtain a second region proposal.

The second region proposal in this embodiment is obtained by performing object detection on the first image based on the item description information of the first item. The second region proposal may include one or more region proposals; or may be empty, that is, no region proposal is obtained.

In some optional examples, in step 2313, the OVD algorithm, the visual grounding algorithm, or the VGM that integrates the OVD algorithm and the visual grounding algorithm may be used to perform object detection on the first image based on the item description information of the first item. For details, reference may be made to description relevant to the foregoing embodiments, which is not repeated here.

When this embodiment is implemented using the VGM in an encoder-decoder structure, the text encoder may be used to perform feature extraction on the input text (such as the item description information of the first item) to obtain the text feature, and the visual encoder may be used to perform feature extraction on the input image (such as the first image) to obtain the visual feature. The features extracted by the encoders are output to the decoder, which outputs the item object bounding box of the first item based on the features output by the encoders. For details, reference may be made to description relevant to the foregoing embodiments, which is not repeated here.

Step 2314: Obtaining the first search result based on the second region proposal.

Specifically, if object detection is performed on the first image based on step 2313 and no region proposal is obtained, that is, the region proposal is empty, step 2314 is not performed, and the first search result indicating that the first item is not found is obtained. If object detection is performed on the first image based on step 2313 and one or more region proposals are obtained, the first search result indicating that the first item is found is obtained.

Based on this embodiment, if the first item information includes the item description information of the first item but does not include the feature information of the first item, search for the first item may be performed directly using the item description information of the first item.

Optionally, referring again to FIG. 5, in another illustrative embodiment of the method for searching for an item, step 23 may further include the following steps.

Step 2315: In response to that the first item information includes feature information of the first item but does not include item description information of the first item, performing object detection on the first image to obtain a third region proposal.

In the operation 2315, object detection may be performed on the first image using any object detection algorithm, to obtain the third region proposal.

The third region proposal in this embodiment is obtained by performing object detection on the first image. The third region proposal may include one or more region proposals. If the third region proposal includes a plurality of region proposals, steps 2316 and 2317 are performed for each region proposal included in the third region proposal.

In step 2315, if object detection is performed on the first image and no region proposal is obtained, steps 2316 and 2317 are not performed, and the first search result indicating that the first item is not found is obtained.

Step 2316: Performing image feature extraction on the third region proposal to obtain third candidate feature information.

Step 2317: Determining, based on similarity between the third candidate feature information and the feature information of the first item, whether the first image includes an image corresponding to the first item, to obtain the first search result.

In some optional examples, for a specific implementation of step 2317, reference may be made to the implementation of step 2312 described above, which is not repeated here. Based on this embodiment, if the first item information includes the feature information of the first item but does not include the item description information of the first item, the first image may be searched for the first item by directly using the feature information of the first item.

Optionally, referring again to FIG. 4, in some possible implementations, after the first search result is obtained according to any one of the embodiments shown in FIG. 4 and FIG. 5, the following step may also be included.

Step 24: In response to that the first search result indicates that the first item is found, sending an alarm message to the first user as a reminder that the first item is left behind in the first place.

In some optional examples, the alarm message may be sent to a terminal device of the first user in the item query system, and the terminal device may display the alarm message to the first user in a manner preset by the first user or in a default manner set in the item query system.

In some optional examples, based on alarm setting information preset by the first user, such as alarm devices and alarm forms (such as sound, text, light signals, and vibration), the alarm message may be sent to the first user in the corresponding alarm form using the alarm device specified by the first user. When the first user does not set the alarm setting information, a default alarm mode set in the item query system may be used to send the alarm message to the first user. For example, if it is detected that a smartwatch of the first user is worn, the alarm message may be sent to the first user by means of controlling vibration of the smartwatch, or the alarm message may be sent to the first user by means of playing a prompt message in voice through a mobile terminal of the first user. A specific manner of sending the alarm message to user is not limited in this embodiment of this disclosure.

Based on this embodiment, after the first item is found in the first image, the alarm message may be sent to the first user to remind the first user in a timely manner that the first item is left behind in the first place.

After the first search result is obtained according to any one of the embodiments shown in FIG. 4 and FIG. 5, if the first search result indicates that the first item is not found, the corresponding alarm operation shown in step 24 is not performed.

Optionally, in some possible implementations, the item query system in this embodiment of this disclosure may include at least one of a registered place information table and a registered item information table of the first user.

The registered place information table of the first user may include registered place information of at least one registered place registered by the first user in the item query system. The registered place information of each registered place may include place information of each registered place and sensor information corresponding to each registered place. The place information of each registered place uniquely identifies one registered place in the item query system. The place information may include at least one of information of the place: a name, a number, and a location in the place. For example, in an optional example, the place information of a registered place is: Residence 1-Living Room, indicating that the identified place is the living room of the residence 1.

The registered item information table of the first user may include item registration information of at least one registered item registered by the first user in the item query system. The item registration information of each registered item may include item information and a first place list of each registered item. The item information of each registered item may include at least one of an image and item description information of each registered item. When the item information of each registered item includes the image, the item registration information of each registered item may also include feature information obtained by performing feature extraction on the image. The first place list of each registered item includes place information of a second place where each registered item is allowed to be left behind. Therefore, the first place list may also be referred to as a place whitelist.

Based on this embodiment, the alarm-triggering item information corresponding to the first place in step 2110 may be determined based on the registered place information table of the first user and each first place list in the registered item information table. For details, reference may be made to the description in the embodiment shown in FIG. 7.

Optionally, on the basis of any one of the embodiments shown in FIG. 4 and FIG. 5, steps of performing place registration and item registration in the item query system may also be included. The two steps may be performed simultaneously or in any sequence, which is not limited in this embodiment of this disclosure.

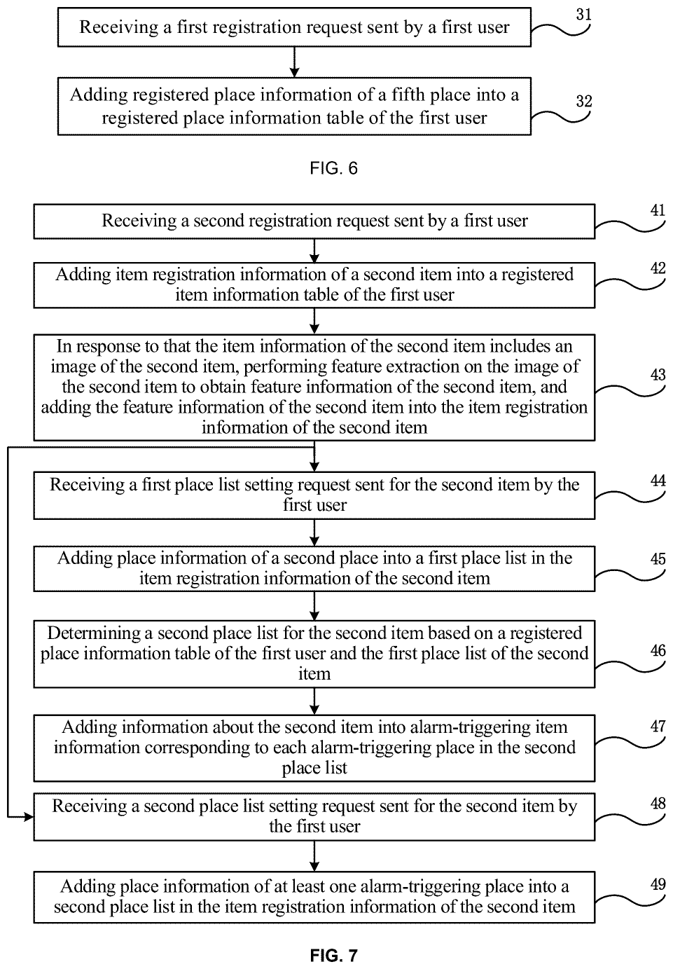

FIG. 6 is a schematic flowchart of place registration according to an illustrative embodiment of this disclosure. As shown in FIG. 6, in some possible implementations, taking the first user as an example, place registration may be performed in the item query system as follows.

Step 31: Receiving a first registration request sent by the first user, where the first registration request includes registered place information of a fifth place, and the registered place information for the fifth place includes place information of the fifth place and sensor information corresponding to the fifth place.

The first registration request is used to request place registration in the item query system.

The fifth place in this embodiment is a place requested to register by the first user (such as the living room of the residence 1, a balcony of the residence 1, or a vehicle cabin), that is, a to-be-registered place, being a place that has not yet been registered in the item query system. The fifth place may include one place, indicating that the first user requests to register one place in the item query system this time; or the fifth place may also include a plurality of places, indicating that the first user requests to register a plurality of places in bulk in the item query system this time, which is not limited in embodiments of this disclosure.

In some optional examples, the first user may send the first registration request through a terminal device of the first user in the item query system.

Step 32: Adding the registered place information of the fifth place into a registered place information table of the first user, to achieve registration of the fifth place.

After the registration of the fifth place in the item query system is completed, the fifth place changes from a to-be-registered place to a registered place of the first user in the item query system. Based on this embodiment, the place registration of the user in the item query system is implemented.

Based on this embodiment, the place registration of the first user in the item query system is implemented. According to coverage of sensors (such as cameras) in the item query system, the first user may register places in the item query system where networked sensors are deployed, such that search for, or alarm triggered by, a left-behind item, is performed on the registered places later.

FIG. 7 is a schematic flowchart of item registration according to an illustrative embodiment of this disclosure. As shown in FIG. 7, in some possible implementations, taking the first user as an example, item registration may be performed in the item query system as follows.

Step 41: Receiving a second registration request sent by the first user, where the second registration request includes item information of a second item, and the item information of the second item includes at least one of an image and item description information of the second item.

The first registration request is used to request item registration in the item query system.

The second item in this embodiment is an item requested to register by the first user (such as a wallet, a staff badge, a handbag, a lipstick, a headphone, a mobile terminal, or any other item), that is, a to-be-registered item, being an item that has not yet been registered in the item query system. The second item may be a same item as the first item, or may include the first item. The second item may include one item, indicating that the first user requests to register one item in the item query system this time; or the second item may also include a plurality of items, indicating that the first user requests to register a plurality of items in bulk in the item query system this time, which is not limited in embodiments of this disclosure.

The item description information may include any information used to describe attributes of the item, for example but is not limited to information used to describe a name, a color, and a size of the item; and may be sent after being input by the user through a terminal device in the item query system that includes an information input unit (such as a human-computer interaction interface). For example, in some optional examples, the item description information is “a blue stuff badge” or “a light-colored lipstick”. The image of the second item may be acquired for the second item and sent by the user through a terminal device (such as a mobile terminal or IVI) that has an image acquisition capability and includes an information input unit.

In some optional examples, the first user may send the second registration request through the terminal device of the first user in the item query system.

Step 42: Adding item registration information of the second item into a registered item information table of the first user, where the item registration information of the second item includes item information of the second item.

Step 43: In response to that the item information of the second item includes the image of the second item, performing feature extraction on the image of the second item to obtain feature information of the second item, and adding the feature information of the second item into the item registration information of the second item, to achieve registration of the second item.

According to steps 41 and 43 in this embodiment, for the second item, the OVD algorithm, the visual grounding algorithm, or the VGM that integrates the OVD algorithm and the visual grounding algorithm may also be used to perform visual grounding directed at the second item on the image of the second item based on the item description information of the second item, and then perform feature extraction on the image of the second item to obtain the feature information of the second item.

After the registration of the second item in the item query system is completed, the second item changes from a to-be-registered item to a registered item of the first user in the item query system.

Based on this embodiment, the item registration of the first user in the item query system is implemented. As required, left-behind items for which search is to be performed or leaving-behind of which is to trigger alarm may be registered by the first user in the item query system.

In this embodiment of this disclosure, a place whitelist (referred to as the first place list in this embodiment of this disclosure), that is, a list of places where the second item is allowed to be left behind, may be directly set for the second item during a registration process of an item (referred to as the second item). Alternatively, a place whitelist may be set for the second item at any time after the registration of the second item is completed, which is not limited in embodiments of this disclosure.

Optionally, taking setting the place whitelist after the registration of the second item is completed as an example, the place whitelist may be set for the second item as follows.

Step 44: Receiving a first place list setting request sent for the second item by the first user, where the first place list setting request includes place information of a second place where the second item is allowed to be left behind.

The first place list setting request is used to request setting of the first place list in the item query system.

The second place may also be referred to as a whitelist place. When the second item is left behind in the second place, no alarm may be triggered.

In some optional examples, the first user may send the first place list setting request through the terminal device of the first user in the item query system.

Step 45: Adding the place information of the second place into a first place list in the item registration information of the second item.

Based on this embodiment, a place whitelist is set for an item. The first user may set a place whitelist for the second item according to requirements. For example, when registered places of the first user include a residence and a private vehicle, if the second item (such as a wallet) is allowed to be left behind in the residence but is not allowed to be left behind in the vehicle, the residence may be set as a whitelist place.

Optionally, after the place whitelist is set for the second item, based on the registered place information table of the first user and the place whitelist of the second item, alarm-triggering item information corresponding to a non-whitelist place (also referred to as an alarm-triggering place) may be generated in the item query system for the second item, so as to trigger an alarm when the second item is left behind in the non-whitelist place, to remind the first user that the second item is left behind in the alarm-triggering place. The non-whitelist place is a registered place where the second item is not allowed to be left behind. In some optional implementations, referring to FIG. 7, after step 45, the alarm-triggering item information corresponding to the alarm-triggering place may be generated for the second item as follows.

Step 46: Determining a second place list for the second item based on the registered place information table of the first user and the first place list of the second item, where the second place list includes place information of at least one alarm-triggering place, and the alarm-triggering place is a place where the second item is not allowed to be left behind.

In step 46, all registered places, except the places in the first place list of the second item, that are included in the registered place information table of the first user may be obtained to serve as alarm-triggering places in the second place list of the second item.

Step 47: Adding information about the second item into alarm-triggering item information corresponding to each alarm-triggering place in the second place list, that is, adding the information about the second item as a piece of alarm-triggering item information into the alarm-triggering item information corresponding to each alarm-triggering place.

The information about the second item includes at least a part of the item registration information of the second item, for example, may include at least one of the image, the item description information, and the feature information of the second item. The alarm-triggering item information corresponding to each alarm-triggering place may include information about at least one registered item of the first user in the item query system.

Based on this embodiment, the alarm-triggering item information corresponding to each alarm-triggering place may be generated. For example, when the registered places of the first user include a residence and a private vehicle, if the second item (such as the wallet) is allowed to be left behind in the residence but is not allowed to be left behind in the vehicle, after the residence is et as a whitelist place by the first user, the item query system may add the second item (such as the wallet) into the alarm-triggering item information corresponding to the vehicle.

Alternatively, in this embodiment of this disclosure, a non-place whitelist (that is, the second place list), that is, a list of places where the item is not allowed to be left behind, may be directly set for the second item during the registration process of the second item. Alternatively, a non-place whitelist may be set for the second item at any time after registration of an item is completed, which is not limited in embodiments of this disclosure.

Optionally, referring again to FIG. 7, the non-place whitelist (that is, the second place list) may be set for the second item as follows.

Step 48: Receiving a second place list setting request sent for the second item by the first user, where the second place list setting request includes place information of at least one alarm-triggering place, and the alarm-triggering place is a place where the second item is not allowed to be left behind.

When the second item is left behind in any alarm-triggering place, an alarm may be triggered to remind the first user that the second item has been left behind in the alarm-triggering place.

Step 49: Adding the place information of the at least one alarm-triggering place into a second place list in the item registration information of the second item.

Based on this embodiment, the first user may directly set a non-place whitelist for the second item as required. For example, when the registered places of the first user include a residence and a private vehicle, if the second item (such as the wallet) is allowed to be left behind in the residence but is not allowed to be left behind in the vehicle, the first user may directly set the vehicle as the alarm-triggering place for the second item (such as the wallet) without setting a place whitelist for the second item (such as the wallet).

Optionally, after the second place list is set for the second item, the item registration information, corresponding to each alarm-triggering place in the second place list, of the registered item of the first user in the item query system may be obtained to determine the alarm-triggering item information corresponding to each alarm-triggering place. In other words, at least a part of the information, corresponding to each alarm-triggering place, in the item registration information of each registered item in the item query system, such as at least one of an image, item description information, and feature information of each registered item may be obtained to serve as the alarm-triggering item information corresponding to each alarm-triggering place.

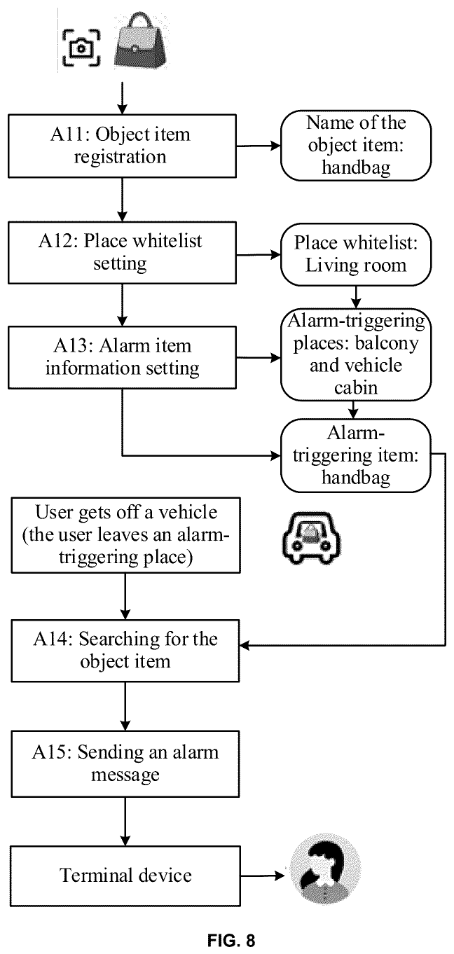

FIG. 8 is a flowchart of applying a method for searching for an item according to another illustrative embodiment of this disclosure. An alarm may be given for a left-behind item according to this application embodiment. As shown in FIG. 8, as an application of another illustrative embodiment of the method for searching for an item shown in FIG. 4 to FIG. 7, taking that an object item (corresponding to the first item or second item in the foregoing embodiments) is a handbag and the sensor is a camera as an example, this application embodiment includes the following steps.

A11: Object item registration: A user takes an image of the object item (the handbag) using a camera on a terminal device (such as a mobile terminal or IVI) in the item query system; and inputs a name of the object item “handbag” as item description information and selects the image of the object item through a human-computer interaction interface on the terminal device, to send an item registration request (that is, the second registration request described above) to a computing device in the item query system. The item registration request includes the image and the name of the object item. The computing device calls the VGM to perform feature extraction on the image of the object item and obtain feature information of the object item. Item registration information of the object item, including the name, the image, and the feature information of the object item, is added to a registered item information table of the user, thus achieving registration of the object item.

A12: Place whitelist setting: The user selects a whitelist place of the object item from pre-registered registered places (such as a living room, a balcony, and a vehicle cabin) through the human-computer interaction interface, and then sends a first place list setting request to the computing device. The computing device adds place information of the whitelist place to a place whitelist (that is, the first place list described above) in the item registration information of the object item, thus achieving setting of the place whitelist. For example, when the registered places include the living room, the balcony, and the vehicle cabin, if the object item is allowed to be left behind in the living room but is not allowed to be left behind in the balcony or the vehicle cabin, the living room is set as a whitelist place. In this case, when the object item is left behind in the living room, no alarm may be triggered.

A13: Alarm item information setting: The computing device determines that other places, except the whitelist place, in the registered places of the user are alarm-triggering places, and adds information about the object item (including the name, the image, and the feature information) into the alarm-triggering item information corresponding to each alarm-triggering place, separately. For example, if the whitelist place of the handbag is the living room, information about the handbag is added to the alarm-triggering item information of the balcony and the vehicle cabin, separately.

A14: Searching for the object item: When the user leaves any alarm-triggering place A (assuming that the user gets off the vehicle and leaves the vehicle cabin), the computing device senses that the user leaves the vehicle cabin through a camera corresponding the vehicle cabin (such as a DMS camera or an OMS camera in the vehicle cabin), and calls the DMS camera or the OMS camera in the vehicle cabin to perform image acquisition. Because the vehicle cabin may correspond to information about a plurality of alarm-triggering items, the VGM is called based on all alarm-triggering item information corresponding to that alarm-triggering place and images acquired by the DMS camera and the OMS camera to perform object detection on all alarm-triggering items one by one. If a suspected alarm-triggering item is found, an image feature of a region proposal where the suspected alarm-triggering item is located is extracted, and is compared with feature information in item registration information of the alarm-triggering item to further determine whether the suspected alarm-triggering item is the alarm-triggering item. If no alarm-triggering item is found, subsequent processes would not be performed, that is, no alarm may be triggered.

A15: Sending an alarm message: After the feature comparison, if it is determined that the suspected alarm-triggering item is the alarm-triggering item, it is determined that the alarm-triggering item is found, and an alarm message is immediately sent to a mobile terminal, a wearable device, or other terminal devices of the user in the item query system, to remind the user that there is an alarm-triggering item (such as a headphone) left behind in the vehicle cabin.

In this application embodiment, steps A14 and A15 are operations triggered by the event that the user leaves any alarm-triggering place, and steps A11 to A13 are optional operations that may be performed in advance.

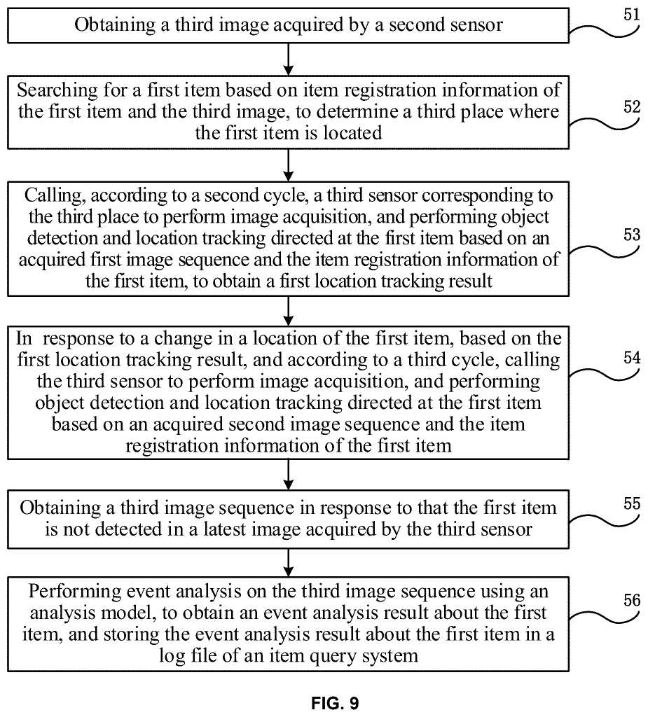

FIG. 9 is an schematic flowchart of a method for searching for an item according to another illustrative embodiment of this disclosure. As shown in FIG. 9, on the basis of any one of the embodiments shown in FIG. 3 to FIG. 7, in this embodiment of the this disclosure, the following steps may also be included.

Step 51: Obtaining a third image acquired by a second sensor.

The second sensor includes a sensor corresponding to the sensor information in the registered place information table of the first user. Because the registered place information table of the first user may include a plurality of registered places and each registered place may correspond to a plurality of sensors, in step 51, sensors corresponding to all sensor information in the registered place information table of the first user may be obtained at one time to serve as second sensors. Steps 51 and 52 in this embodiment are performed to determine a third place where the first item is located. Alternatively, sensors corresponding to a part of the sensor information (such as sensor information corresponding to a preset quantity of registered places) in the registered place information table of the first user may be sequentially obtained to serve as the second sensors. Steps 51 and 52 in this embodiment are performed to determine a third place where the first item is located. If the third place where the first item is located cannot be determined, a sensor corresponding to a next part of the sensor information is obtained to serve as the second sensor, and steps 51 and 52 in this embodiment are performed, until the third place where the first item is located is determined.

When the second sensor includes one sensor, the third image may include one or more images. When the second sensor includes a plurality of sensors, the third image may include one or more images acquired by each sensor in the second sensor, which is not limited in embodiments of this disclosure.

Step 52: Searching for the first item based on the item registration information of the first item and the third image, to determine a third place where the first item is located.

The item registration information of the first item includes item information of the first item. In step 52, search for the first item may be performed based on the item information in the item registration information of the first item and the third image. For a specific implementation, reference may be made to the implementation of searching for the first item based on the first item information and the first image in the foregoing embodiments, which is not repeated here.

In step 52, after the third image including the image corresponding to the first item is determined, the third image including the image corresponding to the first item is used as the target image, so that a place corresponding to the second sensor that acquires the target image may be determined as the third place where the first item is located.

Step 53: Calling, according to a second cycle, a third sensor corresponding to the third place to perform image acquisition, and performing object detection and location tracking on the first item based on an acquired first image sequence and the item registration information of the first item, to obtain a first location tracking result.

The first image sequence may include a plurality of images that are acquired by the third sensor according to the second cycle and are arranged according to an image acquisition sequence.

The second cycle may be set as needed, and may be updated as required. In practical applications, for an item with frequent location changes (such as a mobile terminal), a smaller second cycle (such as 2 minutes) may be set to achieve timely tracking of the item. Moreover, for an item with less frequent location changes (such as a wallet), a larger second cycle (such as 20 minutes) may be set, which is not limited in embodiments of this disclosure.

After the third place where the first item is located is determined, through step 53, the third sensor corresponding to the third place may be specifically called to perform image acquisition according to the second cycle. Based on the item information in the item registration information of the first item, any item detection algorithm may be used to perform object detection on an image acquired by the third sensor, so as to track a location of the first item according to the second cycle. The first location tracking result may be the first image sequence for which the item object bounding box of the first item is labeled.

For an implementation of performing object detection on the image acquired by third sensor based on the item information of the first item, reference may be made to the implementation of searching for the first item based on the first item information and the first image in the foregoing embodiments, which is not repeated here.

Step 54: In response to a change in a location of the first item, based on the first location tracking result, and according to a third cycle, calling the third sensor to perform image acquisition, and performing object detection and location tracking on the first item based on an acquired second image sequence and the item registration information of the first item.

The third cycle is less than the second cycle. The third cycle may be set as needed, for example, may be set to 10 seconds; and may be updated as required.

The second image sequence may include a plurality of images that are acquired by the third sensor according to the third cycle and are arranged according to an image acquisition sequence.

Through step 54, when the location of the first item changes, a location tracking cycle for the first item may be reduced to increase a location tracking frequency, thereby achieving effective location tracking for the first item. For details, reference may be made to the implementation of step 53, which is not repeated here.

Step 55: Obtaining a third image sequence in response to that the first item is not detected in a latest image acquired by the third sensor.

The third image sequence includes at least one image that is acquired by the third sensor at an acquisition moment prior to that of the latest image.

Step 56: Performing event analysis on the third image sequence using an analysis model, to obtain an event analysis result about the first item, and storing the event analysis result about the first item into a log file of the item query system.

The event analysis result may include a possible whereabouts (such as being put in a bag) or a possible location (such as on a sofa) of the first item, and may also include the third image sequence for which the item object bounding box of the first item is labeled, which is not limited in embodiments of this disclosure.

The analysis model may be a pre-trained deep learning model, such as a convolutional neural network (CNN) model, a recurrent neural network (RNN) model, or a long short-term memory (LSTM) network, which is not limited in embodiments of this disclosure. In some optional examples, a plurality of sample image sequences may be obtained. Each sample image sequence includes an image of a sample item, and for which whereabouts information of the sample item is labeled. The plurality of sample image sequences are used to train an initial deep learning model with or without supervision, and the analysis model obtained through training may predict whereabouts or a location of an object in the input image sequence.

According to steps 55 and 56, in the process of performing object detection and location tracking on the first item, if it is found that tracking of the first item fails, that is, the first item disappears from sight, event analysis may be performed on at least one image before the first item disappears from sight, to analyze the possible whereabouts or location of the first item.

Based on this embodiment, locating and location tracking of the registered item are achieved. When the registered item disappears from sight, event analysis may be performed on an image sequence acquired before the registered item disappears from sight. An obtained event analysis result is stored in the log file, so that when later the registered item is not found, possible whereabouts or location of the registered item may be determined based on the event analysis result. In this way, possibility of finding the item is improved, thereby improving efficiency and effects of item search.

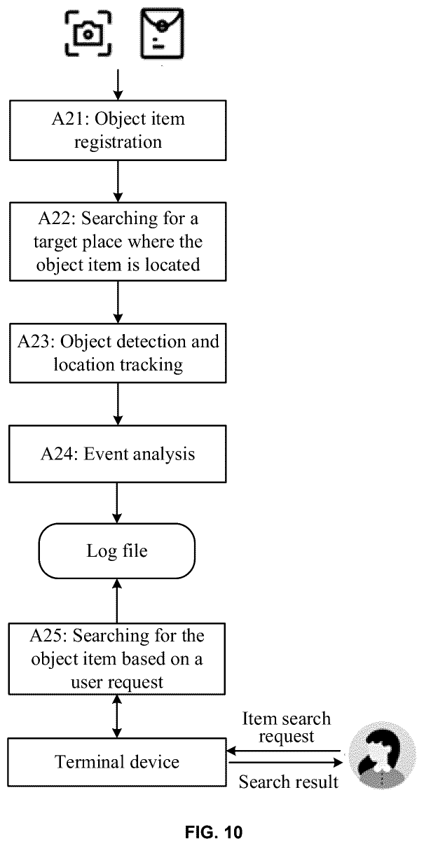

FIG. 10 is a flowchart of applying a method for searching for an item according to still another illustrative embodiment of this disclosure. According to this application embodiment, target tracking may be performed on the registered item. As shown in FIG. 10, as an application of another illustrative embodiment of the method for searching for an item shown in FIG. 9, taking that a object item (corresponding to the first item or second item in the foregoing embodiments) is a staff badge and the sensor is a camera as an example, this application embodiment includes the following steps.

A21: Object item registration: A user takes an image of the object item (the staff badge) using a camera on a terminal device (such as a mobile terminal or IVI) in the item query system; and inputs a name of the object item “staff badge” as item description information and selects the image of the object item through a human-computer interaction interface on the terminal device, to send an item registration request (that is, the second registration request described above) to a computing device in the item query system. The item registration request includes the image and the name of the object item. The computing device calls the VGM to perform feature extraction on the image of the object item and obtain feature information of the object item. Item registration information of the object item, including the name, the image, and the feature information of the object item, is added to a registered item information table of the user, thus achieving registration of the object item.

A22: Searching for a target place where the object item is located: The computing device obtains images acquired by cameras corresponding to all registered places of the user in the item query system. If it is assumed that all the registered places of the user include a living room, a balcony, and a vehicle cabin, images acquired by cameras in the living room, the balcony, and the vehicle cabin are obtained. The VGM is called to perform object detection based on the item registration information of the object item and the images acquired by the cameras in the living room, the balcony, and the vehicle cabin. Moreover, search for the object item is performed by means of feature comparison, to determine the target place where the object item is located (that is, the third place described above), which is assumed to be the living room.

A23: Object detection and location tracking: The computing device periodically (for example, every 2 minutes) calls the images acquired by the camera in the living room; calls the VGM to perform object detection based on the images acquired by the camera in the living room and the item registration information of the object item; and performs location tracking by means of feature comparison, and records a target location. If it is found that the location of the object item changes, a critical event response is triggered. In this case, the computing device shortens a period of object detection and location tracking to increase tracking frequency, and saves an image sequence acquired during the tracking process after the critical event response is triggered (that is, the third image sequence described above).

A24: Event analysis: When the object item disappears from sight (that is, no target is detected), the computing device calls the analysis model to perform event analysis on the third image sequence to obtain an event analysis result of the object item, where the event analysis result includes a possible location or whereabouts (such as being put in a bag) of the object item; and stores the event analysis result in the log file of the item query system.

A25: Searching for the object item based on a user request: When the user initiates an item search request for the object item through a human-computer interaction interface on a terminal device in the item query system, the computing device may obtain a search result of the object item by means of searching images acquired by the camera in the registered place of the user for the object item in combination with querying the log file; and may output the search result to the user by means of text, voice, or images. By combining the manner of querying the log file, possibility of finding the object item is improved, which helps to improve search efficiency for the object item.

In this application embodiment, steps A22 to A24 are operations triggered by an event that registration of the object item is completed, and step A25 is an operation triggered by an event that the item search request sent by the user is received.

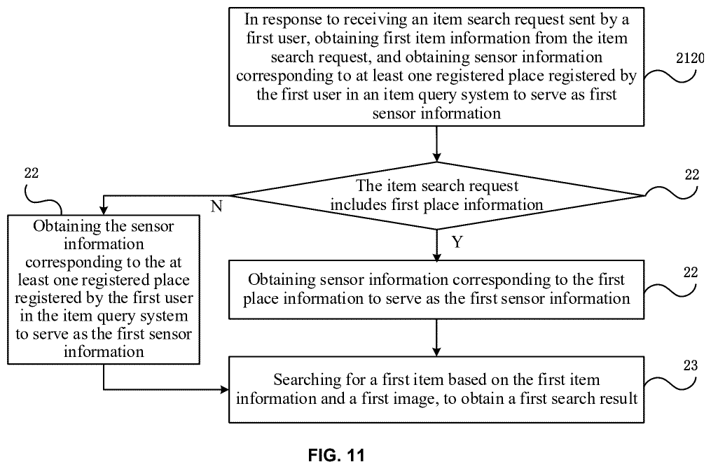

In some other possible implementations, the first event refers to that an item search request sent by the first user is received. The item search request includes the first item information. FIG. 11 is an illustrative schematic flowchart of determining first item information and first sensor information in a method for searching for an item according to still another illustrative embodiment of this disclosure. The still another illustrative embodiment of the method for searching for an item is an embodiment corresponding to the event that the item search request sent by the first user is received. As shown in FIG. 11, on the basis of the embodiment shown in FIG. 3, in this embodiment, step 21 may include the following step.

Step 2120: In response to receiving the item search request sent by the first user, obtaining the first item information from the item search request, and obtaining sensor information corresponding to the at least one registered place registered by the first user in the item query system to serve as the first sensor information.

In some optional examples, in at least one form of voice, text, and images, the first user may initiate the item search request through a human-computer interaction interface of a terminal device in the item query system, such as “Where is my wallet?”, “Please help me find the blue staff badge”, or “Please help me find the lipstick in the image”, to request the item query system to search for items.

Based on this embodiment, when the item search request sent by the first user is received, item information that needs to be found and a sensor corresponding to a corresponding registered place may be determined, so as to obtain images acquired by the sensor. The corresponding registered place is searched for the items based on the item information.

In some optional examples, in step 2120, the obtaining sensor information corresponding to the at least one registered place registered by the first user in the item query system to serve as the first sensor information may include: in response to that the item search request includes first place information, obtaining sensor information corresponding to the first place information to serve as the first sensor information; or in response to that the item search request includes no place information, obtaining the sensor information corresponding to the at least one registered place registered by the first user in the item query system to serve as the first sensor information. The at least one registered place may be all registered places registered by the first user in the item query system, or may be some registered places selected from all the registered places registered by the first user in the item query system in a predetermined manner, such as a manner of sequentially selecting according to a sequence.

In accordance with the embodiment shown in FIG. 11, in some optional examples, in step 22, in response to that the item search request includes the first time information, which is time information used as a search condition, at least one image corresponding to the first time information may be obtained from historical images acquired by the first sensor to serve as the first image. For example, at least one image acquired by each sensor in the first sensor from the first time information may be obtained to serve as the first image, or at least one image acquired by each sensor in the first sensor at at least one adjacent acquisition moment before the first time information may be obtained to serve as the first image. In response to that the item search request does not include the first time information, the first image already acquired by the first sensor is obtained, which may include one or more images acquired by each sensor in the first sensor in a most recent acquisition. Alternatively, the first sensor may be called to perform image acquisition, and each sensor in the first sensor may acquire one or more images, obtaining the first image.

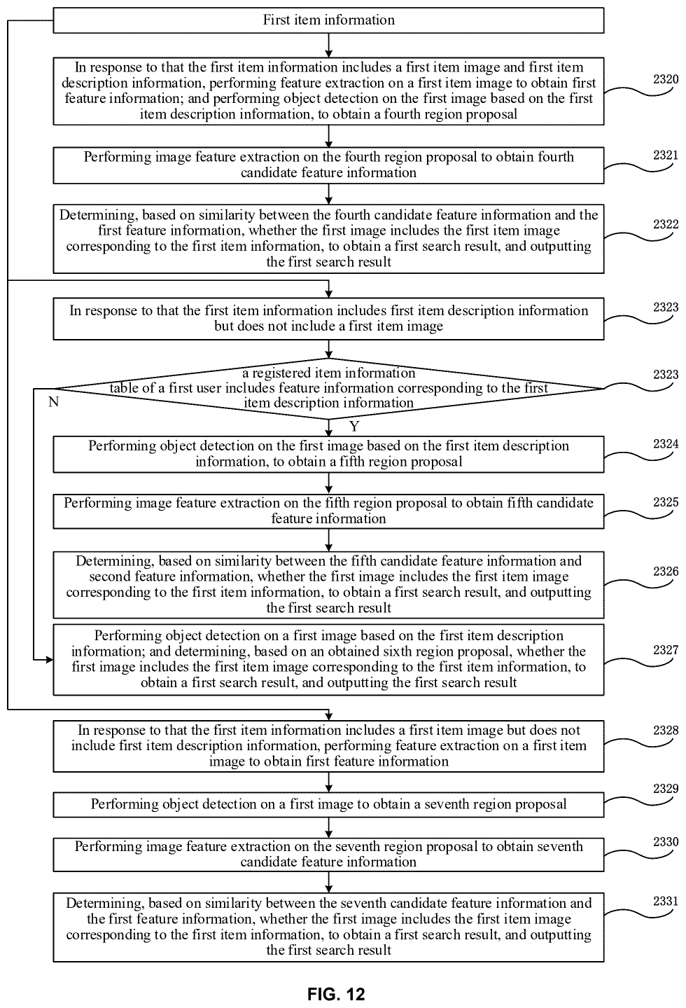

FIG. 12 is an illustrative schematic flowchart of searching for a first item in a method for searching for an item according to still another illustrative embodiment of this disclosure. As shown in FIG. 12, on the basis of the embodiment shown in FIG. 3, in still another illustrative embodiment of the method for searching for an item, step 23 may include the following step.

Step 2320: In response to that the first item information includes a first item image and first item description information, performing feature extraction on the first item image to obtain first feature information; and performing object detection on the first image based on the first item description information, to obtain a fourth region proposal.

In some optional implementations, in step 2320, an OVD algorithm, a visual grounding algorithm, or a VGM that integrates the OVD algorithm and the visual grounding algorithm may be used to perform object detection on the first image based on the first item description information. For details, reference may be made to description relevant to the foregoing embodiments, which is not repeated here.

When this embodiment is implemented using the VGM in an encoder-decoder structure, a text encoder may be used to perform feature extraction on input text (such as the first item description information) to obtain a text feature; an image encoder may be used to perform feature extraction on an input image (such as the first item image) to obtain an image feature, and a visual encoder may be used to perform feature extraction on the input image (such as the first image) to obtain a visual feature. The features extracted by the encoders are output to the decoder, which outputs an item object bounding box of the first item based on the features output by the encoders.

The fourth region proposal in this embodiment is obtained by performing object detection on the first image based on item description information of the first item. The fourth region proposal may include one or more region proposals. If the fourth region proposal includes a plurality of region proposals, steps 2321 and 2322 are performed for each region proposal included in the fourth region proposal.

In step 2320, if object detection is performed on the first image and no region proposal is obtained, steps 2321 and 2322 are not performed, and the first search result indicating that the first item is not found is obtained.

Step 2321: Performing image feature extraction on the fourth region proposal to obtain fourth candidate feature information.

Step 2322: Determining, based on similarity between the fourth candidate feature information and the first feature information, whether the first image includes the first item image corresponding to the first item information, to obtain the first search result, and outputting the first search result.

In some optional examples, for a specific implementation of step 2322, reference may be made to the implementation of step 2312 described above, which is not repeated here.

Based on this embodiment, when the first item information includes the first item image and the first item description information, if the fourth region proposal is obtained by performing object detection on the first image based on the first item description information, it may be considered that a suspected object is detected; and then, the first feature information of the first item image may be compared with features of the fourth region proposal to further determine whether the suspected object is the first item. Search for the first item is performed based on both the item description information and the image of the first item, to determine whether the first image includes an image corresponding to the first item. Thus, accuracy of searching for the first item may be improved.

Optionally, referring again to FIG. 12, in still another illustrative embodiment of the method for searching for an item, step 23 may further include the following steps.

Step 2323: In response to that the first item information includes first item description information but does not include a first item image, determining whether a registered item information table of the first user includes feature information corresponding to the first item description information.

In response to that the registered item information table of the first user includes second feature information corresponding to the first item description information, steps 2324 to 2326 are performed. Otherwise, in response to that the registered item information table of the first user does not include the feature information corresponding to the first item description information, step 2327 is performed.

Step 2324: Performing object detection on the first image based on the first item description information, to obtain a fifth region proposal.

In some optional examples, step 2324 may be implemented using the OVD algorithm, the visual grounding algorithm, or the VGM that integrates the OVD algorithm and the visual grounding algorithm. For details, reference may be made to description relevant to the foregoing embodiments, which is not repeated here.

The fifth region proposal may include one or more region proposals. If the fifth region proposal includes a plurality of region proposals, steps 2325 and 2326 are performed for each region proposal included in the fifth region proposal.

Step 2325: Performing image feature extraction on the fifth region proposal to obtain fifth candidate feature information.

Step 2326: Determining, based on similarity between the fifth candidate feature information and the second feature information, whether the first image includes the first item image corresponding to the first item information, to obtain the first search result, and outputting the first search result.

For a specific implementation of step 2326, reference may be made to the relevant implementation in the foregoing embodiments, which is not repeated here.

Step 2327: Performing object detection on the first image based on the first item description information; and determining, based on an obtained sixth region proposal, whether the first image includes the first item image corresponding to the first item information, to obtain the first search result, and outputting the first search result.

In some optional examples, in step 2327, an OVD algorithm, a visual grounding algorithm, or a VGM that integrates the OVD algorithm and the visual grounding algorithm may be used to perform object detection on the first image based on the first item description information. For details, reference may be made to description relevant to the foregoing embodiments, which is not repeated here.

In step 2327, if object detection is performed on the first image and no region proposal is obtained, the first search result indicating that the first item is not found is obtained.

Based on this embodiment, whether the registered item information table of the first user includes the feature information corresponding to the first item description information may be determined when the first item information only includes the first item description information. If the feature information corresponding to the first item description information is included, search for the first item may be performed based on both the first item description information and the feature information, to determine whether the first image includes the image corresponding to the first item, which improves accuracy of searching for the first item. If the feature information corresponding to the first item description information is not included, search for the first item may be performed directly based on the first item description information, to determine whether the first image includes the image corresponding to the first item. In this way, search for the first item is performed.

Optionally, referring again to FIG. 12, in yet another illustrative embodiment of the method for searching for an item, step 23 may further include the following steps.

Step 2328: In response to that the first item information includes a first item image but does not include first item description information, performing feature extraction on the first item image to obtain first feature information.

Step 2329: Performing object detection on the first image to obtain a seventh region proposal.

In the operation 2329, object detection may be performed on the first image using any object detection algorithm, to obtain the seventh region proposal.

The seventh region proposal in this embodiment is obtained by performing object detection on the first image. The seventh region proposal may include one or more region proposals. If the seventh region proposal includes a plurality of region proposals, steps 2330 and 2331 are performed for each region proposal included in the seventh region proposal.

Step 2330: Performing image feature extraction on the seventh region proposal to obtain seventh candidate feature information.

Step 2331: Determining, based on similarity between the seventh candidate feature information and the first feature information, whether the first image includes the first item image corresponding to the first item information, to obtain the first search result, and outputting the first search result.

For a specific implementation of step 2331, reference may be made to the relevant implementation in the foregoing embodiments, which is not repeated here.

Based on this embodiment, when the first item information only includes the first item image but does not include the first item description information, whether the first image includes the image corresponding to the first item may be determined by means of feature comparison. In this way, search for the first item is performed.

In some optional implementations, in steps 2322, 2326, 2327, and 2331, after whether the first image includes the first item image corresponding to the first item information is determined, the method further includes:

in response to that the first image does not include the first item image, obtaining at least one image from historical images acquired by the first sensor to serve as a fourth image. In an optional example, at least one image acquired by each sensor within a preset time period before an acquisition moment of the first image may be obtained from historical images acquired by each sensor in the first sensor to serve as the fourth image. For example, 6 images acquired by each sensor in the first sensor within 3 hours before the acquisition moment of the first image are obtained to serve as the fourth image. After that, search for the first item is performed based on the first item information and the fourth image, to obtain the first search result. For a specific implementation, reference may be made to the implementation in the foregoing embodiments of this disclosure, which is not repeated here.

Based on this embodiment, when the first item is not found in the first image, historical cached images acquired by each sensor in the first sensor may be called for item searching, thereby improving possibility of finding the first item.

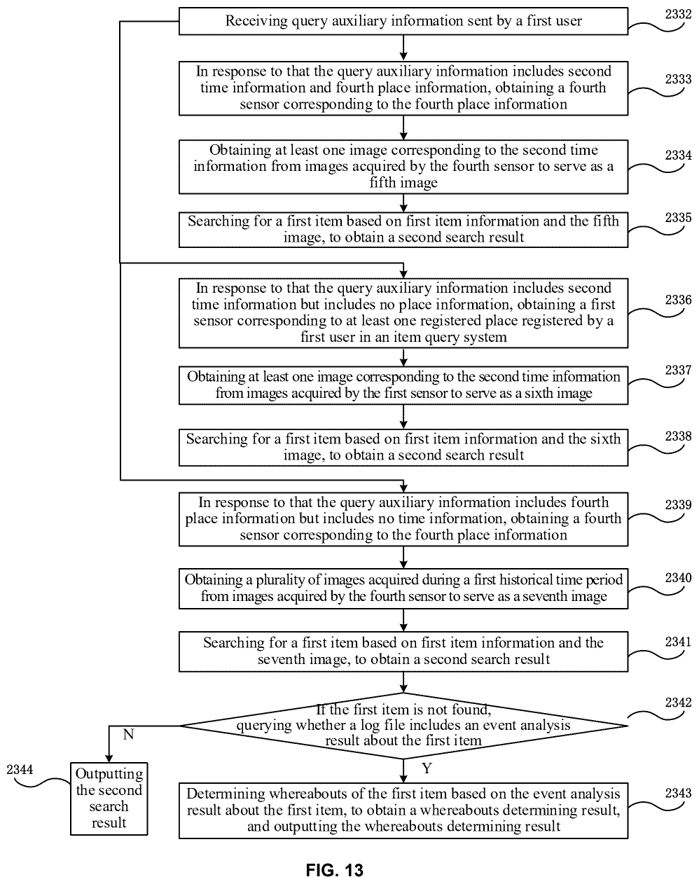

FIG. 13 is another illustrative schematic flowchart of searching for a first item in a method for searching for an item according to still another illustrative embodiment of this disclosure. As shown in FIG. 13, on the basis of the embodiment shown in FIG. 12, if the first search result indicates that the first item is not found, the method may further include the following steps.

Step 2332: Receiving query auxiliary information sent by the first user.

The query auxiliary information is relevant information used for assisting in searching for the first item, that is, prompt information used for searching for the first item, and may include at least one of place information and time information.

The time information in the query auxiliary information refers to time information used for assisting in searching, such as about 3 pm, which is referred to as second time information below. The place information in the query auxiliary information refers to place information used for assisting in searching, such as in a vehicle or on a sofa in a house, which is referred to as fourth place information below.

In some optional examples, the first user may send the query auxiliary information through a terminal device of the first user in the item query system.

In response to that the query auxiliary information includes the second time information and the fourth place information, steps 2333 to 2335 are performed. In response to that the query auxiliary information includes the second time information but does not include the place information, steps 2336 to 2338 are performed. In response to that the query auxiliary information includes the fourth place information but does not include the time information, steps 2339 to 2341 are performed.

Step 2333: Obtaining a fourth sensor corresponding to fourth place information.

At least one registered place registered by the first user in the item query system includes a fourth place corresponding to the fourth place information

In step 2333, a sensor identified by sensor information corresponding to the fourth place information may be obtained from a registered place information table of the first user to serve as the fourth sensor. The fourth sensor may include one or more sensors.

Step 2334: Obtaining at least one image corresponding to the second time information from images acquired by the fourth sensor to serve as a fifth image.

For example, at least one image acquired by each sensor in the fourth sensor from the second time information is obtained to serve as the fifth image, or at least one image acquired by each sensor in the fourth sensor at at least one adjacent acquisition moment before the second time information is obtained to serve as the fifth image, which is not limited in embodiments of this disclosure.

Step 2335: Searching for the first item based on the first item information and the fifth image, to obtain a second search result.

For a specific implementation, reference may be made to the implementation of searching for the first item based on the first item information and the first image in the foregoing embodiments, which is not repeated here.

Step 2336: Obtaining the first sensor corresponding to the at least one registered place registered by the first user in the item query system.

For a specific implementation, reference may be made to the implementation of step 2120 in the foregoing embodiments, which is not repeated here.

Step 2337: Obtaining at least one image corresponding to the second time information from images acquired by the first sensor to serve as a sixth image.

For example, at least one image acquired by each sensor in the first sensor from the second time information is obtained to serve as the sixth image, or at least one image acquired by each sensor in the first sensor at at least one adjacent acquisition moment before the second time information is obtained to serve as the sixth image, which is not limited in embodiments of this disclosure.

Step 2338: Searching for the first item based on the first item information and the sixth image, to obtain a second search result.

For a specific implementation, reference may be made to the implementation of searching for the first item based on the first item information and the first image in the foregoing embodiments, which is not repeated here.

Step 2339: Obtaining a fourth sensor corresponding to fourth place information.

For a specific implementation, reference may be made to the implementation of step 2333 in the foregoing embodiments, which is not repeated here.

Step 2340: Obtaining a plurality of images acquired during a first historical time period from images acquired by the fourth sensor to serve as a seventh image.

The first historical time period may be set as needed. When the item search request includes first time information, the first historical time period may be a preset time period before the first time information, such as within 1 hour before the first time information. When the item search request does not include the first time information, the first historical time period may be a preset time period adjacent to the acquisition moment of the first image, for example, within 2 hours before the acquisition moment of the first image, which is not limited in embodiments of this disclosure.

Step 2341: Searching for the first item based on the first item information and the seventh image, to obtain a second search result.

For a specific implementation, reference may be made to the implementation of searching for the first item based on the first item information and the first image in the foregoing embodiments, which is not repeated here.

Based on this embodiment, when the first item is not found, the query auxiliary information sent by the user may be used as a prompt for narrowing down a search scope, to focus on searching for relevant historical images that may include the first item. This helps to reduce computational resource consumption required for searching and improves possibility of finding the first item.

In some optional examples, the first search result or the second search result may be sent to the terminal device of the first user in the item query system, and the terminal device may display the first search result or the second search result to the first user through a human-computer interaction interface (which serves as an information output unit).

Optionally, referring again to FIG. 13, after the second search result is obtained, if the second search result indicates that the first item is found, the second search result may be output. If the first search result or the second search result indicates that the first item is not found, the following steps may also be included.

Step 2342: Querying whether a log file of the item query system includes an event analysis result about the first item.

In response to that the log file includes the event analysis result about the first item, step 2343 is performed. In response to that the log file does not include the event analysis result about the first item, step 2344 is performed.

Step 2343: Determining whereabouts of the first item based on the event analysis result about the first item, to obtain a whereabouts determining result, and outputting the whereabouts determining result.

Step 2344: Outputting the second search result.

Based on this embodiment, when the first item is not found, if the log file includes the event analysis result about the first item, the whereabouts of the first item may be determined based on the event analysis result about the first item, thus improving a rate of success in finding an item.

In some possible implementations, in any one of the embodiments shown in FIG. 12 and FIG. 13, if the first search result and the second search result indicate that the first item is found in the corresponding image, correspondingly, the first search result and the second search result may include location information of the first item. The location information of the first item may include at least one of: the corresponding image for which an item object bounding box and/or a location coordinate of the first item is labeled, and location description information of the first item. The location description information of the first item is used to describe a location of the first item. For example, taking the first search result as an example, if the first search result indicates that the first item is found in the first image, the first search result may include the location information of the first item, which specifically includes at least one of: the first image for which the item object bounding box and/or the location coordinate of the first item is labeled, and the location description information of the first item (such as on a sofa in a living room).

Based on this embodiment, the location information of the first item may be displayed by means of the image, the location description information, or a combination of the two, so that the user may intuitively obtain the place and/or location where the first item is located.

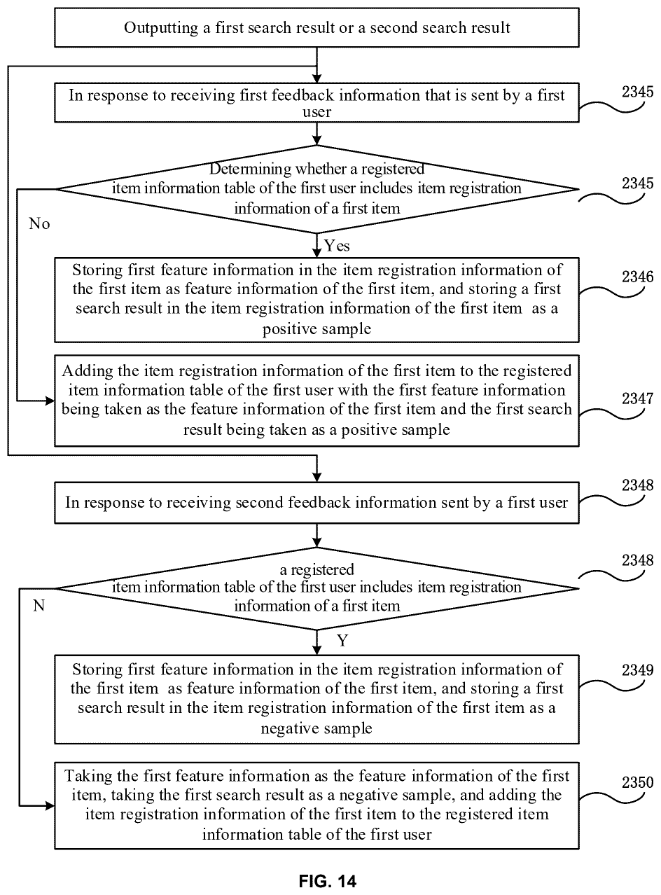

FIG. 14 is still another illustrative schematic flowchart of searching for a first item in a method for searching for an item according to yet another illustrative embodiment of this disclosure. As shown in FIG. 14, on the basis of any one of the embodiments shown in FIG. 12 and FIG. 13, after the first search result or the second search result is output, taking the first search result as an example, this embodiment may further include the following steps.

Step 2345: In response to receiving first feedback information sent by the first user indicating that the first search result is correct, determining whether the registered item information table of the first user includes item registration information of the first item.

In response to that the registered item information table of the first user includes the item registration information of the first item, step 2346 is performed. In response to that the registered item information table of the first user does not include the item registration information of the first item, step 2347 is performed.

Step 2346: Storing the first feature information as feature information of the first item into the item registration information of the first item, and storing the first search result as a positive sample into the item registration information of the first item.

Storing the first feature information as the feature information of the first item into the item registration information of the first item may enrich the feature information of the first item, which helps to improve probability of successfully finding an item and accuracy of the item search result later.

Step 2347: Adding the item registration information of the first item to the registered item information table of the first user with the first feature information being taken as the feature information of the first item and the first search result being taken as a positive sample, where the item registration information of the first item includes the first item information, the feature information of the first item, and the positive sample.

Step 2348: In response to receiving second feedback information sent by the first user indicating that the first search result is wrong, determining whether the registered item information table of the first user includes item registration information of the first item.

In response to that the registered item information table of the first user includes the item registration information of the first item, step 2349 is performed. In response to that the registered item information table of the first user does not include the item registration information of the first item, step 2350 is performed.

Step 2349: Storing the first feature information as feature information of the first item into the item registration information of the first item, and storing the first search result as a negative sample into the item registration information of the first item.

Storing the first feature information as the feature information of the first item into the item registration information of the first item may enrich the feature information of the first item, which helps to improve probability of successfully finding an item and accuracy of the item search result later.

Step 2350: Taking the first feature information as the feature information of the first item, taking the first search result as a negative sample, and adding the item registration information of the first item into the registered item information table of the first user, where the item registration information of the first item includes the first item information, the feature information of the first item, and the negative sample.

In this embodiment, after the second search result is output, steps 2345 to 2350 in the embodiment shown in FIG. 14 may also be performed for the second search result. For a specific implementation, reference may be made to the implementation for the first search result in the embodiment shown in FIG. 14, which is not repeated here.

Based on this embodiment, after the search result about the first item is output to the user, feedback information indicating whether the search result is correct may also be received from the user. If the first item is not registered, the first item may be automatically registered and a current search result may be recorded as a positive sample or a negative sample based on the feedback information of the user that indicates whether the search result is correct, to be used for subsequent searching for the first item, thereby improving accuracy of subsequent search results for a same item and probability of successful search.

Optionally, based on the embodiment shown in FIG. 14, when searching for the first item based on the first item information and the first image in any one of the embodiments shown in FIG. 11 to FIG. 13, the item registration information of the first item may be further combined. To be specific, search for the first item is performed specifically based on the first item information, the first image, and the item registration information of the first item, to obtain the first search result.

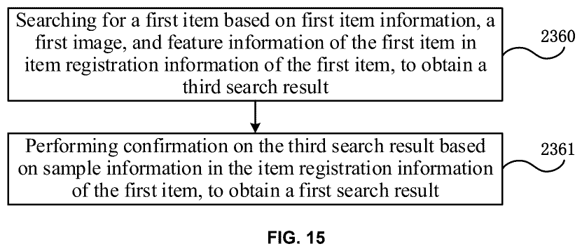

FIG. 15 is yet another illustrative schematic flowchart of searching for a first item in a method for searching for an item according to still yet another illustrative embodiment of this disclosure. As shown in FIG. 15, in some possible implementations, searching for the first item based on the first item information, the first image, and the item registration information of the first item, to obtain the first search result may include the following steps.

Step 2360: Searching for the first item based on the first item information, the first image, and the feature information of the first item in the item registration information of the first item, to obtain a third search result.

In step 2360, the feature information of the first item in the item registration information of the first item is taken as feature information corresponding to the first item information, and search for the first item is performed based on the first item information and the first image.

If the first item information includes the first item image and the first item description information, in some optional examples, based on the implementation in the embodiment shown in FIG. 12, the feature information of the first item may be fused with the first feature information obtained by performing feature extraction on the first item image to obtain a fused feature. The first feature information may be replaced with the fused feature in performing step 2322, to determine whether the first image includes the first item image corresponding to the first item information. Alternatively, in some other optional examples, based on the implementation in the embodiment shown in FIG. 12, in step 2322, it is determined, according to a preset criterion, and based on the similarity between the fourth candidate feature information and the first feature information (referred to as first similarity below) and similarity between the fourth candidate feature information and the feature information of the first item (referred to as second similarity below), whether the first image includes the first item image corresponding to the first item information. For example, the criterion is whether both the first similarity and the second similarity are greater than a second preset threshold, whether an average value of the first similarity and the second similarity is greater than the second preset threshold, etc. When both the first similarity and the second similarity are greater than the second preset threshold, or when the average value of the first similarity and the second similarity is greater than the second preset threshold, it may be determined that the first image includes the first item image. Otherwise, it may be determined that the first image does not include the first item image corresponding to the first item information.

If the first item information includes the first item description information but does not include the first item image, the feature information of the first item may be taken as the second feature information corresponding to the first item description information in the registered item information table of the first user. It is determined, through steps 2323 to 2326 in the embodiment shown in FIG. 12, whether the first image includes the first item image corresponding to the first item information.

If the first item information includes the first item image but does not include the first item description information, in some optional examples, based on the implementations shown in steps 2328 to 2331 in the embodiment shown in FIG. 12, the feature information of the first item may be fused with the first feature information obtained by performing feature extraction on the first item image to obtain the fused feature. The first feature information may be replaced with the fused feature in performing step 2321, to determine whether the first image includes the first item image corresponding to the first item information. Alternatively, in some other optional examples, based on the implementations shown in steps 2328 to 2331 in the embodiment shown in FIG. 12, in step 2331, it is determined, according to a preset criterion, and based on the similarity between the seventh candidate feature information and the first feature information (referred to as third similarity below) and the similarity between the seventh candidate feature information and the feature information of the first item (referred to as fourth similarity below), whether the first image includes the first item image corresponding to the first item information. For example, the criterion is whether both the third similarity and the fourth similarity are greater than the second preset threshold, whether an average value of the third similarity and the fourth similarity is greater than the second preset threshold, etc. When both the third similarity and the fourth similarity are greater than the second preset threshold, or when the average value of the third similarity and the fourth similarity is greater than the second preset threshold, it may be determined that the first image includes the first item image. Otherwise, it may be determined that the first image does not include the first item image corresponding to the first item information.

Step 2361: Performing confirmation on the third search result based on sample information in the item registration information of the first item, to obtain the first search result.

The sample information includes at least one of the positive sample and the negative sample.

In step 2361, if the third search result indicates that the first item is found in the first image, and the item registration information of the first item includes the positive sample, it may be determined whether the third search result is correct based on whether similarity between the third search result and the positive sample is greater than a third preset threshold. It is determined that the third search result is correct only when the similarity between the third search result and the positive sample is greater than the third preset threshold. If the third search result is correct, the third search result is output as the first search result. If the third search result is incorrect, the first search result indicating that the first item is not found is output.

If the third search result indicates that the first item is found in the first image, and the item registration information of the first item includes the negative sample, it may be determined whether the third search result is correct based on whether similarity between the third search result and the negative sample is smaller than a fourth preset threshold. It is determined that the third search result is correct only when the similarity between the third search result and the negative sample is smaller than the fourth preset threshold. If the third search result is correct, the third search result is output as the first search result. If the third search result is incorrect, the first search result indicating that the first item is not found is output.

If the third search result indicates that the first item is found in the first image, and the item registration information of the first item includes both the positive sample and the negative sample, it may be determined whether the third search result is correct based on whether the similarity between the third search result and the positive sample is greater than the third preset threshold and whether the similarity between the third search result and the negative sample is smaller than the fourth preset threshold. If the third search result is correct, the third search result is output as the first search result. If the third search result is incorrect, the first search result indicating that the first item is not found is output. In some optional examples, it may be determined that the third search result is correct when the similarity between the third search result and the positive sample is greater than the third preset threshold and the similarity between the third search result and the negative sample is smaller than the fourth preset threshold, and that the third search result is incorrect if it is the otherwise. Alternatively, in some other optional examples, it may be determined that the third search result is correct when the similarity between the third search result and the positive sample is greater than the third preset threshold or the similarity between the third search result and the negative sample is smaller than the fourth preset threshold. The specific criterion is not limited in this embodiment of this disclosure.

In this embodiment, for specific implementations of determining the similarity between the third search result and the positive sample and the similarity between the third search result and the negative sample, reference may be made to the implementation in any one of the foregoing embodiments, which is not repeated here.

Based on this embodiment, search for an item may be performed with reference to the feature information in the item registration information. Meanwhile, confirmation may be performed on the search result based on the sample information in the item registration information, thereby improving accuracy of the item search result and probability of successful search.

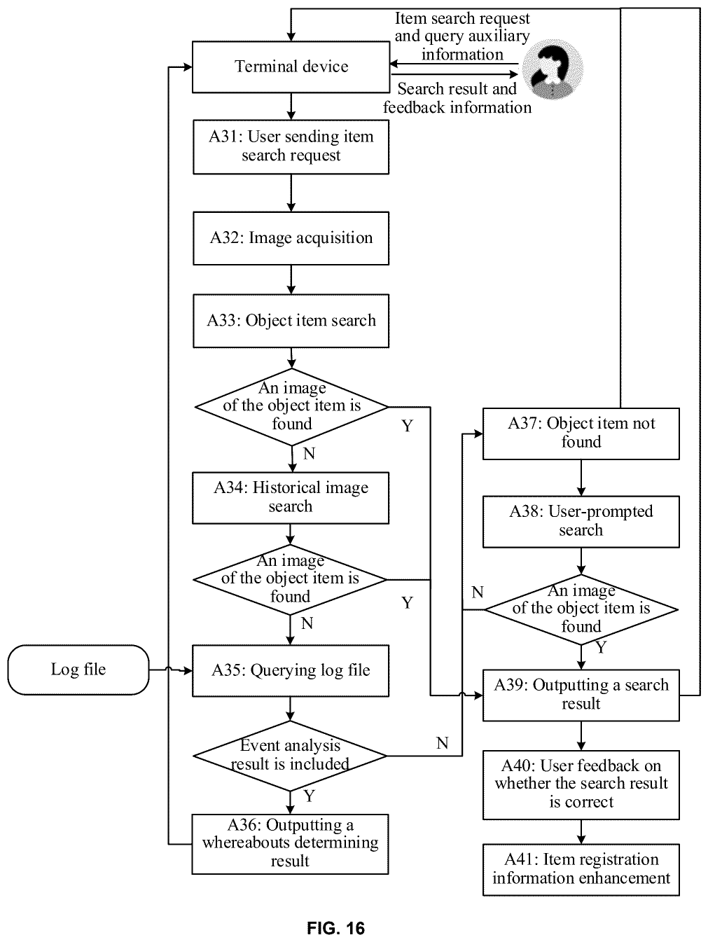

FIG. 16 is a flowchart of applying a method for searching for an item according to yet another illustrative embodiment of this disclosure. Search for an item may be implemented according to this application embodiment. As shown in FIG. 16, as an application of still another illustrative embodiment of the method for searching for an item shown in FIG. 11 to FIG. 15, taking that the object item (corresponding to the first item or the second item in the foregoing embodiments) is a lipstick and the sensor is a camera as an example, this application embodiment includes the following steps.

A31: The user sending an item search request: The user captures an image of the object item (the lipstick) using a camera on a terminal device (such as a mobile terminal or IVI) in the item query system. After the image of the lipstick has been uploaded through a human-computer interaction interface on the terminal device, the user initiates an item search request in a form of a picture in combination with voice or text, such as “Please help me find the lipstick in the picture”. The item search request includes the image of the lipstick and item description information “lipstick”. If the user initiates the item search request in a form of voice, the terminal device may convert the voice into text by means of voice recognition, which is not elaborated here. The terminal device uploads the item search request to the computing device in the item query system.

A32: Image acquisition: The computing device acquires cameras in all registered places (assumably including the living room, the balcony, and the vehicle cabin) registered by the user in the item query system to perform image acquisition, obtaining at least one acquired image. If the user carries place information of a specified place in the item search request, where for example, the item search request is “Find out whether my lipstick is left behind in the vehicle”, the computing device acquires a camera in the registered place “vehicle cabin” registered by the user in the item query system to perform image acquisition, obtaining at least one acquired image.

A33: Object item search: The computing device sequentially traverses each acquired image to search for the object thing. Specifically, the computing device calls the VGM to perform feature extraction on the item search request. For example, the text encoder in the VGM is used to extract a text feature of the item description information, and the image encoder in the VGM is used to extract an image feature of the object item. The text feature and the image feature are input to the decoder in the VGM as prompt information. The visual encoder is used to extract a visual feature of the each acquired image and input the visual feature to the decoder. The decoder performs object detection based on the prompt information and the visual feature, to obtain the item object bounding box; and compares the text feature and the image feature with a feature of the item object bounding box, to determine whether the image of the object item is included in the each acquired image. In this step, if the object item is a registered item, search for the object item may be performed by referring also to the item registration information of the object item, which is not repeated here.

If the image of the object item is not found in all acquired images, step A34 is performed. If the image of the object item is found in any acquired image, step A39 is performed.

A34: Historical image search: If the image of the object item is not found in all acquired images, the computing device calls historical cached images corresponding to respective places (all registered places or the specified place in step A32) (such as 6 images acquired by the cameras corresponding to the respective places within last 3 hours) to search for the object item in a mode of step A33.

If the image of the object item is not found in all historical cached images, step A35 is performed. If the image of the object item is still not found in any one historical image, step A39 is performed.

A35: Querying the log file: If the image of the object item is still not found in all historical cached images, the computing device queries whether the event analysis result of the object item is included in the log file. If the event analysis result about the first item is included in the log file, whereabouts of the object item is determined based on the event analysis result to obtain a whereabouts determining result. After that, step A36 is performed. If the event analysis result about the first item is not included in the log file, step A37 is performed.

A36: Outputting the whereabouts determining result: The computing device returns the whereabouts determining result of the object item to the human-computer interaction interface of the terminal device.

After that, any subsequent steps in this embodiment are not performed.

A37: Object item not found: If the event analysis result about the first item is not included in the log file, the computing device returns, to the human-computer interaction interface of the terminal device, a null value or a search result message indicating that the object item is not found.

A38: User-prompted search: In response to receiving the query auxiliary information sent by the user through the human-computer interaction interface, such as “I used it in the living room at 2 pm”, the computing device obtains 2 images corresponding to time information “2 pm” in the query auxiliary information from historical images acquired by a camera corresponding to the place information “living room” in the query auxiliary information, and searches for the object item in the mode of step A33.

If the image of the object item is still not found in the historical images based on the query auxiliary information, step A37 is performed. If the image of the object item is found in any one historical image based on the query auxiliary information, step A39 is performed.

A39: Outputting the search result: If the image of the object item is found in any one acquired image, the computing device returns the search result of the object item to the human-computer interaction interface of the terminal device, where the search result includes location description information of the object item (such as “the lipstick is on the sofa in the living room”) and an image labeled with an item object bounding box bounding the object item. The terminal device displays the search result to the user in at least one form of text, voice, an image, etc.

A40: User feedback on whether the search result is correct: The user sends, through the human-computer interaction interface on the terminal device, feedback information (that is, the first feedback information or the second feedback information described above) about whether the search result is correct.

A41: Item registration information enhancement: If the object item is not registered, the computing device automatically registers the object item and generates item registration information of the object item. If the user feeds back that the search result is correct, the computing device stores the query result in the item registration information of the object item as a positive sample, and adds the image feature of the object item to the item registration information of the object item for subsequent object item searches. If the user feeds back that the search result is wrong, the computing device stores the query result in the item registration information of the object item as a negative sample, and adds the image feature of the object item to the item registration information of the object item for subsequent object item searches.

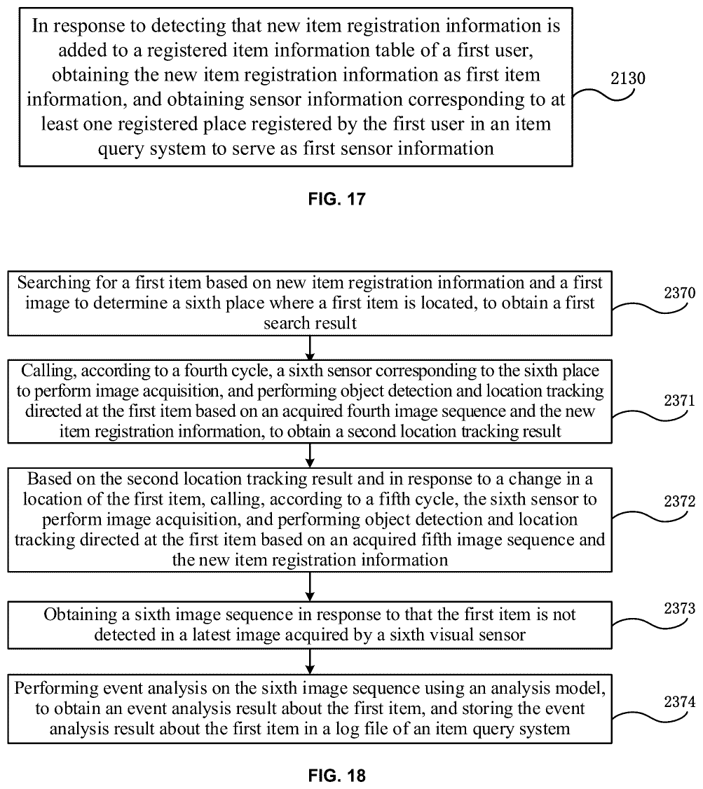

In some other possible implementations, the first event refers to detecting that new item registration information is added to the registered item information table of the first user. FIG. 17 is a flowchart of searching for a first item in a method for searching for an item according to still yet another illustrative embodiment of this disclosure. The still yet another illustrative embodiment of the method for searching for an item is an embodiment corresponding to the event of detecting that new item registration information is added to the registered item information table of the first user. As shown in FIG. 17, in this embodiment, on the basis of the embodiment shown in FIG. 3, step 21 may include the following step.

Step 2130: In response to detecting that new item registration information is added to a registered item information table of the first user, obtaining the new item registration information as the first item information, and obtaining sensor information corresponding to at least one registered place registered by the first user in an item query system to serve as the first sensor information.

For details, reference may be made to the various illustrative implementations corresponding to step 21, which is not repeated here.

In accordance with the embodiment shown in FIG. 17, in some optional examples, in step 22, the first image already acquired by the first sensor may be obtained. The first image may include one or more images acquired by each sensor in the first sensor in a most recent acquisition. Alternatively, each sensor in the first sensor may be called to perform image acquisition, and each sensor may acquire one or more images, obtaining the first image.

FIG. 18 is a flowchart of determining first item information and first sensor information in a method for searching for an item according to yet another illustrative embodiment of this disclosure. As shown in FIG. 18, on the basis of the embodiment shown in FIG. 3, in the yet another illustrative embodiment of the method for searching for an item, step 23 may include the following step.

Step 2370: Searching for the first item based on the new item registration information and the first image to determine a sixth place where the first item is located, to obtain the first search result.

The new item registration information includes item information of the first item. In step 2370, search for the first item may be performed based on the item information in the new item registration information and the first image. For a specific implementation, reference may be made to the implementation of searching for the first item based on the first item information and the first image in the foregoing embodiments, which is not repeated here.

In step 2370, after the first image including the image corresponding to the first item has been determined, the first image including the image corresponding to the first item is taken as the target image, and a place corresponding to the sensor that acquires the target image may be determined as the sixth place where the first item is located.

Optionally, referring again to FIG. 18, in some possible implementations, after the first search result has been obtained through step 2370, the following steps may also be included.

Step 2371: Calling, according to a fourth cycle, a sixth sensor corresponding to the sixth place to perform image acquisition, and performing object detection and location tracking directed at the first item based on an acquired fourth image sequence and the new item registration information, to obtain a second location tracking result.

The fourth image sequence may include a plurality of images that are acquired by the sixth sensor according to the second cycle and are arranged according to an image acquisition sequence.

The fourth cycle may be set as needed, and may be updated as required. In practical applications, for an item with frequent location changes (such as a mobile terminal), a smaller fourth cycle (such as 2 minutes) may be set to achieve timely tracking of the item. Moreover, for an item with less frequent location changes (such as a wallet), a larger fourth cycle (such as 2 minutes) may be set, which is not limited in embodiments of this disclosure.

After the sixth place where the first item is located has been determined, through step 2371, the sixth sensor corresponding to the sixth place may be specifically called to perform image acquisition according to the fourth cycle. Based on the item information in the item registration information of the first item, any thing detection algorithm may be used to perform object detection on an image acquired by the third sensor, so as to track a location of the first item according to the second cycle. The first location tracking result may be the first image sequence labeled with the item object bounding box of the first item.

For an implementation of performing object detection on the image acquired by the third sensor based on the item information of the first item, reference may be made to the implementation of searching for the first item based on the first item information and the first image in the foregoing embodiments, which is not repeated here.

Step 2372: Based on the second location tracking result and in response to a change in a location of the first item, calling, according to a fifth cycle, the sixth sensor to perform image acquisition, and performing object detection and location tracking directed at the first item based on an acquired fifth image sequence and the new item registration information.

The fifth cycle is less than the fourth cycle. The fifth cycle may be set as needed, for example, to 10 seconds; and may be updated as required.

The fifth image sequence may include a plurality of images that are acquired by the sixth sensor according to the fifth cycle and are arranged according to an image acquisition sequence.

Through step 2372, when the location of the first item changes, a location tracking cycle for tracking the first item may be reduced to increase a location tracking frequency, thereby achieving effective location tracking of the location of the first item. For details, reference may be made to the implementation of step 2371, which is not repeated here.

Step 2373: Obtaining a sixth image sequence in response to that the first item is not detected in a latest image acquired by a sixth visual sensor.

The sixth image sequence includes at least one image that is acquired by the sixth visual sensor at an acquisition moment prior to that of the latest image.

Step 2374: Performing event analysis on the sixth image sequence using an analysis model, to obtain an event analysis result about the first item, and storing the event analysis result about the first item in a log file of the item query system.

The event analysis result may include a possible whereabouts (such as being put in a bag) or a possible location (such as on a sofa) of the first item, and may also include the sixth image sequence labeled with the item object bounding box of the first item, which is not limited in embodiments of this disclosure.

The analysis model may be a pre-trained deep learning model. For specific implementation of the deep learning model and a manner for performing event analysis on the sixth image sequence, reference may be made to step 56 described above, which is not repeated here.

For specific implementation of the steps in this embodiment, reference may be made to description relevant to the embodiment shown in FIG. 9, which is not repeated here.

Based on this embodiment, locating and location tracking directed at the registered item are achieved. When the registered item disappears from sight, event analysis may be performed on an image sequence acquired before the registered item disappears from sight. An obtained event analysis result is stored in the log file, so that when later the registered item is not found, possible whereabouts or location of the registered item may be determined based on the event analysis result. In this way, possibility of finding the item is improved, thereby improving efficiency and effects of item search.

In some possible implementations, the method for searching for an item in any embodiment of this disclosure may be implemented using the Internet of Things system in any one of the foregoing embodiments of this disclosure that is configured as the item query system, and may be specifically implemented using the computing device in the item query system. The item query system includes at least one sensor 11 and at least one end-side device 12. The at least one sensor 11 is deployed in a place corresponding to the item query system, and the at least one end-side device 12 includes one or more terminal devices which the first user or the family of the first user is authorized to use. A first end-side device 120 of the at least one end-side device 12 is configured as the computing device for implementing the embodiments of the method for searching for an item in this disclosure. The computing device may also be referred to as a device for searching for an item.

For the specific implementations of a place, a sensor, and an end-side device corresponding to the item query system, reference may be made to description relevant to the embodiments of the Internet of Things system described above, which is not repeated here.

In the various embodiments of the method for searching for an item implemented based on the item query system in this embodiment, the user may send relevant information to the computing device through the human-computer interaction interface (serving as an information input unit) of each terminal device in the item query system, and receive feedback information sent by the computing device through the human-computer interaction interface (serving as an information output unit) of the terminal device. Alternatively, the user may also receive relevant information sent by the computing device through other terminal devices in the item query system, which is not limited in embodiments of this disclosure. In this way, data involved in an item query process only circulate between private devices within the family domain, without having to be uploaded to cloud. Thus, privacy security of the user is ensured effectively.

### Illustrative Apparatus

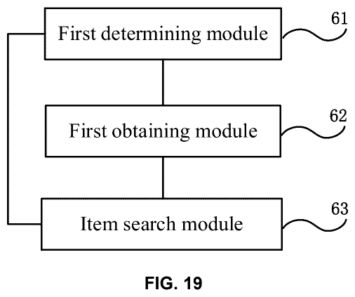

FIG. 19 is a schematic diagram of a structure of a computing device according to an illustrative embodiment of this disclosure. The computing device in this embodiment of this disclosure may be configured to implement various embodiments of the method for searching for an item in this disclosure, and therefore may also be referred to as a device for searching for an item. As shown in FIG. 19, the computing device in this embodiment includes:

a first determining module 61, configured to determine first item information and first sensor information corresponding to a first event, where the first sensor information includes sensor information of a first sensor, the first sensor includes a sensor corresponding to at least one registered place, and each registered place of the at least one registered place is a place registered in the item query system;

a first obtaining module 62, configured to obtain a first image acquired by the first sensor; and

an item search module 63, configured to search for a first item based on the first item information and the first image, to obtain a first search result.

In some possible implementations, the first event refers to that a first user leaves a first place. In this implementation, the first determining module 61 is specifically configured to: in response to detecting that the first user leaves the first place, obtain alarm-triggering item information corresponding to the first place to serve as the first item information, and obtain sensor information corresponding to the first place to serve as the first sensor information. The first place is a registered place registered by the first user in the item query system, the alarm-triggering item information includes information about at least one alarm-triggering item, and an alarm-triggering item is an item registered by the first user as not to be left behind in a corresponding registered place. Accordingly, in this implementation, the first obtaining module 62 is specifically configured to: obtain the first image already acquired by the first sensor; or call the first sensor to perform image acquisition to obtain the first image.

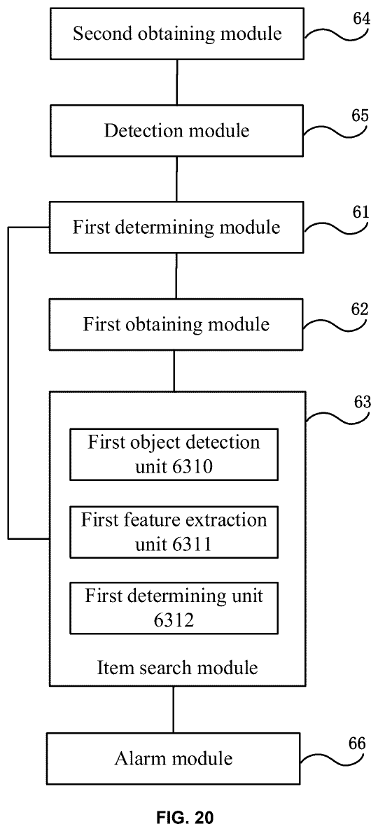

FIG. 20 is a schematic diagram of a structure of a computing device according to another illustrative embodiment of this disclosure. As shown in FIG. 20, in accordance with the foregoing implementation, in this embodiment, the computing device may also include: a second obtaining module 64, configured to obtain, according to a first cycle, a second image acquired by the first sensor; and a detection module 65, configured to perform first detection directed at the first user based on the second image, and determine, based on an obtained first detection result, whether the first user has left the first place.

Optionally, referring again to FIG. 20, in some possible implementations, the item search module 63 may include a first object detection unit 6310, a first feature extraction unit 6311, and a first determining unit 6312.

In some optional examples, the first object detection unit 6310 is configured to: in response to that the first item information includes item description information and feature information of the first item, perform object detection on the first image based on the item description information of the first item, to obtain a first region proposal; the first feature extraction unit 6311 is configured to perform image feature extraction on the first region proposal to obtain first candidate feature information; and the first determining unit 6312 is configured to determine, based on similarity between the first candidate feature information and the feature information of the first item, whether the first image includes an image corresponding to the first item, to obtain the first search result.

In some other optional examples, the first object detection unit 6310 is configured to: in response to that the first item information includes item description information of the first item but does not include feature information of the first item, perform object detection on the first image based on the item description information of the first item, to obtain a second region proposal; and the first determining unit 6312 is configured to obtain the first search result based on the second region proposal.

In still some other optional examples, the first object detection unit 6310 is configured to: in response to that the first item information includes feature information of the first item but does not include item description information of the first item, perform object detection on the first image to obtain a third region proposal; the first feature extraction unit 6311 is configured to perform image feature extraction on the third region proposal to obtain third candidate feature information; and the first determining unit 6312 is configured to determine, based on similarity between the third candidate feature information and the feature information of the first item, whether the first image includes an image corresponding to the first item, to obtain the first search result.

Optionally, referring again to FIG. 20, in some other possible implementations, the computing device may also include an alarm module 66, configured to: in response to that the first search result indicates that the first item is found, send an alarm message to the first user as a reminder that the first item is left behind in the first place.

Optionally, in some possible implementations, the computing device applies to an item query system. The item query system includes at least one of a registered place information table and a registered item information table of the first user. The registered place information table of the first user includes registered place information of at least one registered place registered by the first user in the item query system, and the registered place information of the each registered place includes place information of the each registered place and sensor information corresponding to the each registered place. The registered item information table of the first user includes item registration information of at least one registered item registered by the first user in the item query system, and item registration information of each registered item includes item information and a first place list of the each registered item. The item information of the each registered item includes at least one of an image and item description information of the each registered item. When the item information of the each registered item includes the image of the each registered item, the item registration information of the each registered item also includes feature information obtained by performing feature extraction on the image of the each registered item. The first place list of the each registered item includes place information of a second place where the each registered item is allowed to be left behind. The alarm-triggering item information corresponding to the first place is determined based on the registered place information table of the first user and each first place list in the registered item information table.

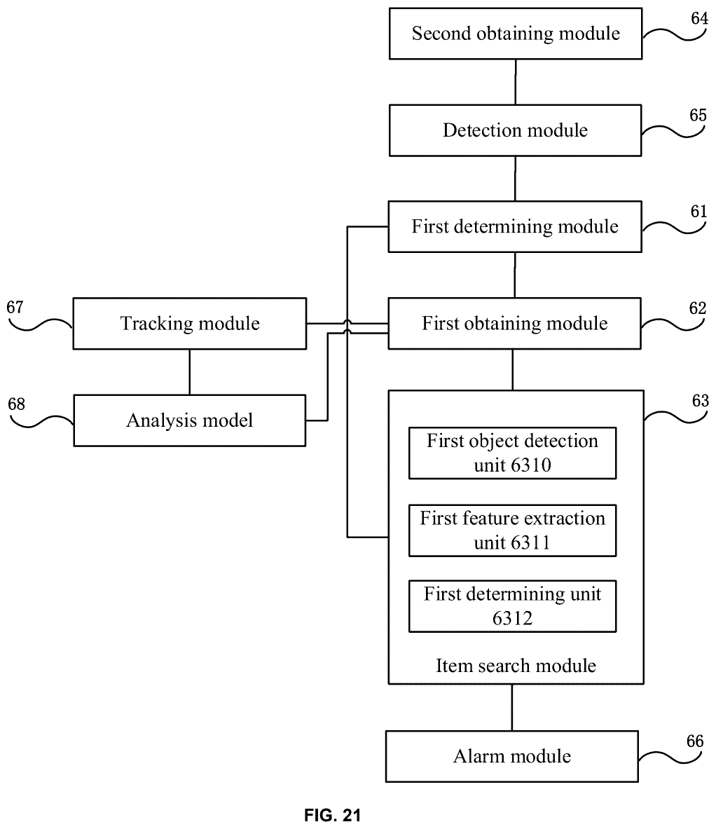

FIG. 21 is a schematic diagram of a structure of a computing device according to still another illustrative embodiment of this disclosure. As shown in FIG. 21, the computing device in this embodiment may further include a tracking module 67 and an analysis model 68. The first obtaining module 62 is further configured to obtain a third image acquired by a second sensor, where the second sensor include a sensor corresponding to sensor information in the registered place information table of the first user. The item search module 63 is further configured to search for the first item based on item registration information of the first item and the third image, to determine a third place where the first item is located. The first obtaining module 62 is further configured to call, according to a second cycle, a third sensor corresponding to the third place to perform image acquisition. The tracking module 67 is configured to perform object detection and location tracking directed at the first item based on a first image sequence acquired by the third sensor and the item registration information of the first item, to obtain a first location tracking result. In response to a change in a location of the first item and based on the first location tracking result, the first obtaining module 62 is further configured to call, according to a third cycle, the third sensor to perform image acquisition. The tracking model 67 is further configured to perform object detection and location tracking directed at the first item based on a second image sequence acquired by the third sensor and the item registration information of the first item, where the third cycle is less than the second cycle. The first obtaining module 62 is further configured to obtain a third image sequence in response to that the first item is not detected in a latest image acquired by the third sensor. The third image sequence includes at least one image that is acquired by the third sensor at an acquisition moment prior to that of the latest image. The analysis model 68 is configured to perform event analysis on the third image sequence, to obtain an event analysis result about the first item, and store the event analysis result about the first item in a log file of the item query system.

In some other possible implementations, the first event refers to that an item search request sent by the first user is received. The item search request includes the first item information. In this implementation, the first determining module 61 is specifically configured to: in response to receiving the item search request sent by the first user, obtain the first item information from the item search request, and obtain sensor information corresponding to the at least one registered place registered by the first user in the item query system to serve as the first sensor information. For example, in response to that the item search request includes first place information, sensor information corresponding to the first place information is obtained to serve as the first sensor information; or in response to that the item search request includes no place information, the sensor information corresponding to the at least one registered place registered by the first user in the item query system is obtained to serve as the first sensor information.

The first obtaining module 62 is specifically configured to: in response to that the item search request includes first time information, obtain at least one image corresponding to the first time information from historical images acquired by the first sensor to serve as the first image; and in response to that the item search request includes no time information, obtain the first image already acquired by the first sensor, or call the first sensor to perform image acquisition to obtain the first image.

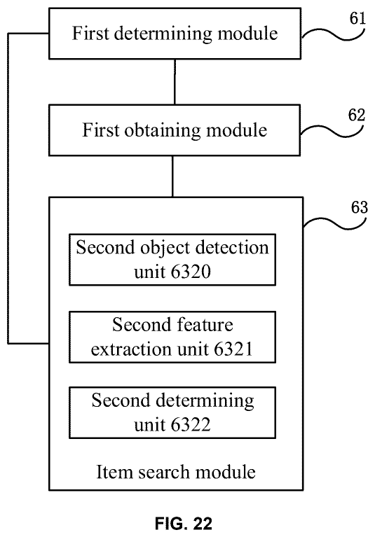

FIG. 22 is a schematic diagram of a structure of a computing device according to yet another illustrative embodiment of this disclosure. As shown in FIG. 22, in accordance with the foregoing implementation, in this embodiment, the item search module 63 may include a second object detection unit 6320, a second feature extraction unit 6321, and a second determining unit 6322.

In some optional examples, the second object detection unit 6320 is configured to: in response to that the first item information includes a first item image and first item description information, perform object detection on the first image based on the first item description information, to obtain a fourth region proposal; the second feature extraction unit 6321 is configured to perform feature extraction on the first item image to obtain first feature information, and perform image feature extraction on the fourth region proposal to obtain fourth candidate feature information; and the second determining unit 6322 is configured to determine, based on similarity between the fourth candidate feature information and the first feature information, whether the first image includes the first item image corresponding to the first item information, to obtain the first search result, and output the first search result.

In some other optional examples, the item search module 63 may also include a third determining unit 6323, configured to: in response to that the first item information includes first item description information but does not include a first item image, determine whether a registered item information table of the first user includes feature information corresponding to the first item description information. The second object detection unit 6320 is configured to: in response to that the registered item information table of the first user includes second feature information corresponding to the first item description information, perform object detection on the first image based on the first item description information to obtain a fifth region proposal. The second feature extraction unit 6321 is configured to perform image feature extraction on the fifth region proposal to obtain fifth candidate feature information. The second determining unit 6322 is configured to determine, based on similarity between the fifth candidate feature information and the second feature information, whether the first image includes the first item image corresponding to the first item information, to obtain the first search result, and output the first search result. The second object detection unit 6320 is further configured to: in response to that the registered item information table of the first user does not includes the feature information corresponding to the first item description information, perform object detection on the first image based on the first item description information. The second determining unit 6322 is used for the second object detection unit 6320 to determine, based on an obtained sixth region proposal, whether the first image includes the first item image corresponding to the first item information, to obtain the first search result, and output the first search result.

In still some other optional examples, the second feature extraction unit 6321 is configured to: in response to that the first item information includes a first item image but does not include first item description information, perform feature extraction on the first item image to obtain first feature information; the second object detection unit 6320 is further configured to perform object detection on the first image to obtain a seventh region proposal; the second feature extraction unit 6321 is further configured to perform image feature extraction on the seventh region proposal to obtain seventh candidate feature information; and the second determining unit 6322 is configured to determine, based on similarity between the seventh candidate feature information and the first feature information, whether the first image includes the first item image corresponding to the first item information, to obtain the first search result, and output the first search result.

Optionally, based on any one of the embodiments shown in FIG. 22, based on a determining result of the second determining unit 6322 about whether the first image includes the first item image corresponding to the first item information, the first obtaining module 62 may be further configured to: in response to that the first image does not include the first item image, obtain at least one image from historical images acquired by the first sensor to serve as a fourth image. The item search module 63 is further configured to search for the first item based on the first item information and the fourth image, to obtain the first search result.

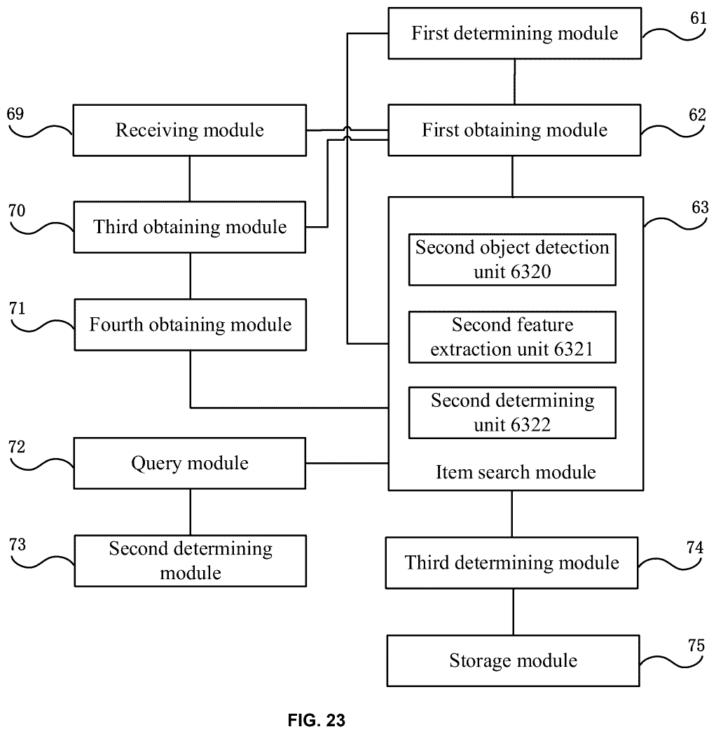

FIG. 23 is a schematic diagram of a structure of a computing device according to still yet another illustrative embodiment of this disclosure. As shown in FIG. 23, based on any one of the embodiments shown in FIG. 22, in this embodiment, the computing device may further include a receiving module 69, a third obtaining module 70, and a fourth obtaining module 71. The first search result indicates that the first item is found. After the first search result is output by the item search module 63, in some optional examples, the receiving module 69 is configured to receive query auxiliary information sent by the first user; the third obtaining module 70 is configured to: in response to that the query auxiliary information includes second time information and fourth place information, obtain a fourth sensor corresponding to the fourth place information, where the at least one registered place registered by the first user in the item query system includes a fourth place corresponding to the fourth place information; the fourth obtaining module 71 is configured to obtain at least one image corresponding to the second time information from images acquired by the fourth sensor to serve as a fifth image; and the item search module 63 is further configured to search for the first item based on the first item information and the fifth image, to obtain a second search result.

In some other optional examples, the third obtaining module 70 is configured to: in response to that the query auxiliary information includes second time information but includes no place information, obtain the first sensor corresponding to the at least one registered place registered by the first user in the item query system; the fourth obtaining module 71 is configured to obtain at least one image corresponding to the second time information from images acquired by the first sensor to serve as a sixth image; and the item search module 63 is further configured to search for the first item based on the first item information and the sixth image, to obtain a second search result.

In still some other optional examples, the third obtaining module 70 is configured to: in response to that the query auxiliary information includes fourth place information but includes no time information, obtain a fourth sensor corresponding to the fourth place information; the fourth obtaining module 71 is configured to obtain a plurality of images acquired during a first historical time period from images acquired by the fourth sensor to serve as a seventh image; and the item search module 63 is further configured to search for the first item based on the first item information and the seventh image, to obtain a second search result.

Optionally, referring again to FIG. 23, in a further embodiment, the computing device may further include a query module 72 and a second determining module 73. If the second search result indicates that the first item is not found, after the second search result is obtained by the item search module 63, the query module 72 is configured to query whether a log file of the item query system includes an event analysis result about the first item. The second determining module 73 is configured to determine, based on the query result of the query module 72 and in response to that the log file includes the event analysis result about the first item, whereabouts of the first item based on the event analysis result about the first item, to obtain a whereabouts determining result, and output the whereabouts determining result; and output the second search result in response to that the log file does not include the event analysis result about the first item.

In some possible implementations, when the first search result indicates that the first item is found in the first image, the first search result may include location information of the first item. The location information of the first item specifically includes at least one of: the first image labeled with an item object bounding box and/or a location coordinate of the first item, or location description information of the first item.

Optionally, referring again to FIG. 23, in a further embodiment, the computing device may further include a third determining module 74 and a storage module 75. After the first search result is output by the item search module 63, in some optional examples, the third determining module 74 is configured to: in response to receiving first feedback information sent by the first user indicating that the first search result is correct, determine whether the registered item information table of the first user includes item registration information of the first item. The storage module 75 is configured to: in response to that the registered item information table of the first user includes the item registration information of the first item, store the first feature information into the item registration information of the first item as feature information of the first item, and store the first search result into the item registration information of the first item as a positive sample; and in response to that the registered item information table of the first user does not include the item registration information of the first item, add the item registration information of the first item to the registered item information table of the first user with the first feature information being taken as the feature information of the first item and the first search result being taken as a positive sample, where the item registration information of the first item includes the first item information, the feature information of the first item, and the positive sample.

In some other optional examples, the third determining module 74 is configured to: in response to receiving second feedback information sent by the first user indicating that the first search result is wrong, determine whether the registered item information table of the first user includes item registration information of the first item. The storage module 75 is configured to: in response to that the registered item information table of the first user includes the item registration information of the first item, store the first feature information into the item registration information of the first item as feature information of the first item, and store the first search result into the item registration information of the first item as a negative sample; and in response to that the registered item information table of the first user does not include the item registration information of the first item, take the first feature information as the feature information of the first item, take the first search result as a negative sample, and add the item registration information of the first item to the registered item information table of the first user, where the item registration information of the first item includes the first item information, the feature information of the first item, and the negative sample.

In some possible implementations, the item search module 63 is specifically configured to search for the first item based on the first item information, the first image, and the item registration information of the first item, to obtain the first search result.

For example, in some optional examples, the item search module 63 is specifically configured to search for the first item based on the first item information, the first image, and the feature information of the first item in the item registration information of the first item, to obtain a third search result; and perform confirmation on the third search result based on sample information in the item registration information of the first item, to obtain the first search result. The sample information includes at least one of the positive sample and the negative sample.

In some other possible implementations, the first event refers to that it is detected that new item registration information is added to the registered item information table of the first user. In this implementation, the first determining module 61 is specifically configured to: in response to detecting that new item registration information is added to the registered item information table of the first user, obtain the new item registration information and take the obtained information as the first item information, and obtain sensor information corresponding to at least one registered place registered by the first user in the item query system to serve as the first sensor information.

Accordingly, the item search module 63 is specifically configured to search for the first item based on the new item registration information and the first image to determine a sixth place where the first item is located, to obtain the first search result.

Illustrative embodiments of the method for searching for an item, the computing device, the Internet of Things system, and the item query system in this disclosure correspond to each other, and for details, reference may be made to each other for corresponding implementation manners. Details are not described herein again. When the Internet of Things system provided in the illustrative embodiments of this disclosure is configured as an item query system, one terminal device in the first end-side device 120 may include the computing device provided in the illustrative embodiments of this disclosure; or one terminal device in the first end-side device 120 may be configured as the computing device provided in the illustrative embodiments of this disclosure, for implementing the method for searching for an item provided in the illustrative embodiments of this disclosure.

For beneficial technical effects corresponding to the illustrative embodiments of the method for searching for an item, the computing device, the Internet of Things system, and the item query system in this disclosure, reference may also be made to each other, which is not repeated here.

### Illustrative Electronic Device

An embodiment of this disclosure further provides an electronic device. The electronic device includes: a processor; and a memory configured to store processor-executable instructions. The processor is configured to read the executable instructions from the memory, and execute the instructions to implement the method for searching for an item according to any one of the foregoing embodiments.

The electronic device may be taken as the first end-side device in any one of the foregoing illustrative embodiments or may be configured as the computing device in any one of the foregoing illustrative embodiments, to implement the method for searching for an item according to any one of the foregoing embodiments.

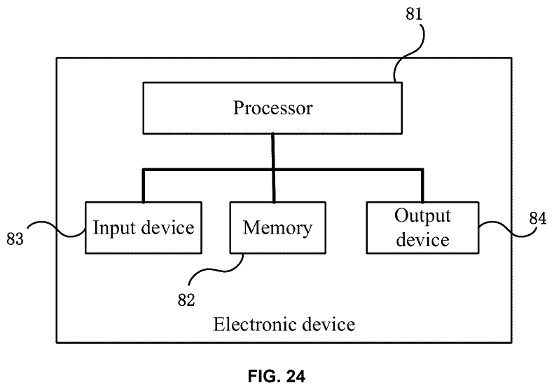

FIG. 24 is a diagram of a structure of an electronic device according to an embodiment of this disclosure. The electronic device includes at least one processor 81 and a memory 82.

The processor 81 may be a central processing unit (CPU) or another form of processing unit having a data processing capability and/or an instruction execution capability, and may control other components in the electronic device to implement desired functions. The processor 81 may serve as a computing resource, providing computing power to a computing device to implement the method for searching for an item according to any one of the foregoing embodiments.

The memory 82 may include one or more computer program products, which may include various forms of computer readable storage media, such as a volatile memory and/or a non-volatile memory. The volatile memory may include, for example, a random access memory (RAM) and/or a cache. The nonvolatile memory may include, for example, a read-only memory (ROM), a hard disk, and a flash memory. The memory 82 may also be configured to store at least a part of sensor acquired data (such as images acquired by at least one sensor 11) involved in the item query system, a registered place information table, a registered item information table, alarm-triggering item information, a log file, a registration user information table, authorization information for using the item query system, and other relevant information. One or more computer program instructions may be stored on a computer readable storage medium. The processor 81 may execute the one or more program instructions to implement the method for searching for an item according to the various embodiments of this disclosure that are described above and/or other desired functions.

In an example, the electronic device may further include an input device 83 and an output device 84. These components are connected to each other through a bus system and/or another form of connection mechanism (not shown).

The input device 83 may receive various forms of information input by a user. The input device 83 may include, for example, a keyboard, a mouse, a touch screen, a microphone, a camera, or other human-computer interaction interfaces, for acquiring various types of information input by the user in forms of text, voice, images, and the like, which may include but are not limited to: an item search request, query auxiliary information, feedback information about a search result, configuration information of the item query system (such as information about sensors and terminal devices included in the item query system, and the authorization information for using the item query system), various types of registration information (such as registered place information, item registration information, and registration user information), various types of setting information (such as a place whitelist and a non-place whitelist).

The output device 84 may output various types of information or signals to the outside, and may include, for example, a display, a speaker, a seat, a window, a steering wheel, a vibration sensor, or other human-computer interaction interfaces, a communication network, and a remote output device connected to the communication network.

Certainly, for simplicity, FIG. 24 shows only some of components in the electronic device that are related to this disclosure, and components such as a bus and an input/output interface are omitted. In addition, according to specific application situations, the electronic device may further include any other appropriate components.

Illustrative computer program product and computer readable storage medium

In addition to the foregoing method and device, embodiments of this disclosure may also provide a computer program product, which includes computer program instructions. When the computer program instructions are executed by a processor, the processor is enabled to perform the steps, of the method for searching for an item according to the embodiments of this disclosure, that are described in the “Illustrative method” section described above.

The computer program product may be program code, written with one or any combination of a plurality of programming languages, which is configured to perform the steps in the embodiments of this disclosure. The programming languages include an object-oriented programming language such as Java or C++, and further include a conventional procedural programming language such as a “C” language or a similar programming language. The program code may be entirely or partially executed on a user computing device, executed as an independent software package, partially executed on the user computing device and partially executed on a remote computing device, or entirely executed on the remote computing device or a server.

In addition, the embodiments of this disclosure may further relate to a computer readable storage medium, which stores computer program instructions. When the computer program instructions are run by the processor, the processor is enabled to perform the steps, of the method for searching for an item according to the embodiments of this disclosure, that are described in the “Illustrative method” section described above.

The computer readable storage medium may be one readable medium or any combination of a plurality of readable media. The readable medium may be a readable signal medium or a readable storage medium. The readable storage medium includes, for example but is not limited to electricity, magnetism, light, electromagnetism, infrared ray, or a semiconductor system, an apparatus, or a device, or any combination of the above. More specific examples (a non-exhaustive list) of the readable storage medium include: an electrical connection with one or more conducting wires, a portable disk, a hard disk, a random access memory (RAM), a read-only memory (ROM), an erasable programmable read-only memory (EPROM or a flash memory), an optical fiber, a portable compact disk read-only memory (CD-ROM), an optical storage device, a magnetic storage device, or any suitable combination of the above.

Basic principles of this disclosure are described above in combination with specific embodiments. However, advantages, superiorities, and effects mentioned in this disclosure are merely examples but are not for limitation, and it cannot be considered that these advantages, superiorities, and effects are necessary for each embodiment of this disclosure. In addition, specific details described above are merely for examples and for ease of understanding, rather than limitations. The details described above do not limit that this disclosure must be implemented using the foregoing specific details.

A person skilled in the art may make various modifications and variations to this disclosure without departing from the spirit and the scope of this application. In this way, if these modifications and variations of this application fall within the scope of the claims and equivalent technologies of the claims of this disclosure, this disclosure also intends to include these modifications and variations.

1. A method for searching for an item, which is applied to an item query system, the method comprising:
determining first item information and first sensor information corresponding to a first event, wherein the first sensor information comprises sensor information of a first sensor, the first sensor comprises a sensor corresponding to at least one registered place, and each registered place of the at least one registered place is a place registered in the item query system;
obtaining a first image acquired by the first sensor; and
searching for a first item based on the first item information and the first image, to obtain a first search result.

2. The method according to claim 1, wherein the first event comprises a first user leaving a first place,
wherein the determining first item information and first sensor information corresponding to a first event comprises:
in response to detecting that the first user leaves the first place, obtaining alarm-triggering item information corresponding to the first place to serve as the first item information, and obtaining sensor information corresponding to the first place to serve as the first sensor information, wherein the first place is one of at least one registered place registered by the first user in the item query system, the alarm-triggering item information comprises information about at least one alarm-triggering item, and an alarm-triggering item of the at least one alarm-triggering item is an item registered by the first user as not to be left behind in a corresponding registered place.

3. The method according to claim 2, further comprising: before detecting that the first user leaves the first place,
obtaining, according to a first cycle, a second image acquired by the first sensor; and
performing first detection directed at the first user based on the second image, and determining, based on an obtained first detection result, whether the first user has left the first place.

4. The method according to claim 2, wherein the searching for a first item based on the first item information and the first image, to obtain a first search result comprises:
in response to that the first item information comprises item description information and feature information of the first item, performing object detection on the first image based on the item description information of the first item, to obtain a first region proposal;
performing image feature extraction on the first region proposal to obtain first candidate feature information; and
determining, based on similarity between the first candidate feature information and the feature information of the first item, whether the first image comprises an image corresponding to the first item, to obtain the first search result;
or
in response to that the first item information comprises item description information of the first item but does not comprise feature information of the first item, performing object detection on the first image based on the item description information of the first item, to obtain a second region proposal; and
obtaining the first search result based on the second region proposal;
or
in response to that the first item information comprises feature information of the first item but does not comprise item description information of the first item, performing object detection on the first image to obtain a third region proposal;
performing image feature extraction on the third region proposal to obtain third candidate feature information; and
determining, based on similarity between the third candidate feature information and the feature information of the first item, whether the first image comprises an image corresponding to the first item, to obtain the first search result.

5. The method according to claim 3, wherein the searching for a first item based on the first item information and the first image, to obtain a first search result comprises:
in response to that the first item information comprises item description information and feature information of the first item, performing object detection on the first image based on the item description information of the first item, to obtain a first region proposal;
performing image feature extraction on the first region proposal to obtain first candidate feature information; and
determining, based on similarity between the first candidate feature information and the feature information of the first item, whether the first image comprises an image corresponding to the first item, to obtain the first search result;
or
in response to that the first item information comprises item description information of the first item but does not comprise feature information of the first item, performing object detection on the first image based on the item description information of the first item, to obtain a second region proposal; and
obtaining the first search result based on the second region proposal;
or
in response to that the first item information comprises feature information of the first item but does not comprise item description information of the first item, performing object detection on the first image to obtain a third region proposal;
performing image feature extraction on the third region proposal to obtain third candidate feature information; and
determining, based on similarity between the third candidate feature information and the feature information of the first item, whether the first image comprises an image corresponding to the first item, to obtain the first search result.

6. The method according to claim 2, further comprising: after obtaining the first search result,
in response to that the first search result indicates that the first item is found, sending an alarm message to the first user as a reminder that the first item is left behind in the first place.

7. The method according to claim 2, wherein the item query system comprises at least one of a registered place information table and a registered item information table of the first user,
wherein the registered place information table of the first user comprises registered place information of at least one registered place registered by the first user in the item query system, and the registered place information of the each registered place comprises place information of the each registered place and sensor information corresponding to the each registered place;
the registered item information table of the first user comprises item registration information of at least one registered item registered by the first user in the item query system, and item registration information of each registered item of the at least one registered item comprises item information and a first place list of the each registered item, wherein the item information of the each registered item comprises at least one of an image and item description information of the each registered item; when the item information of the each registered item comprises the image of the each registered item, the item registration information of the each registered item also comprises feature information obtained by performing feature extraction on the image of the each registered item; and the first place list of the each registered item comprises place information of a second place where the each registered item is allowed to be left behind; and
the alarm-triggering item information corresponding to the first place is determined based on the registered place information table of the first user and each first place list in the registered item information table.

8. The method according to claim 3, wherein the item query system comprises at least one of a registered place information table and a registered item information table of the first user,
wherein the registered place information table of the first user comprises registered place information of at least one registered place registered by the first user in the item query system, and the registered place information of the each registered place comprises place information of the each registered place and sensor information corresponding to the each registered place;
the registered item information table of the first user comprises item registration information of at least one registered item registered by the first user in the item query system, and item registration information of each registered item of the at least one registered item comprises item information and a first place list of the each registered item, wherein the item information of the each registered item comprises at least one of an image and item description information of the each registered item; when the item information of the each registered item comprises the image of the each registered item, the item registration information of the each registered item also comprises feature information obtained by performing feature extraction on the image of the each registered item; and the first place list of the each registered item comprises place information of a second place where the each registered item is allowed to be left behind; and
the alarm-triggering item information corresponding to the first place is determined based on the registered place information table of the first user and each first place list in the registered item information table.

9. The method according to claim 4, wherein the item query system comprises at least one of a registered place information table and a registered item information table of the first user,
wherein the registered place information table of the first user comprises registered place information of at least one registered place registered by the first user in the item query system, and the registered place information of the each registered place comprises place information of the each registered place and sensor information corresponding to the each registered place;
the registered item information table of the first user comprises item registration information of at least one registered item registered by the first user in the item query system, and item registration information of each registered item of the at least one registered item comprises item information and a first place list of the each registered item, wherein the item information of the each registered item comprises at least one of an image and item description information of the each registered item; when the item information of the each registered item comprises the image of the each registered item, the item registration information of the each registered item also comprises feature information obtained by performing feature extraction on the image of the each registered item; and the first place list of the each registered item comprises place information of a second place where the each registered item is allowed to be left behind; and
the alarm-triggering item information corresponding to the first place is determined based on the registered place information table of the first user and each first place list in the registered item information table.

10. The method according to claim 6, wherein the item query system comprises at least one of a registered place information table and a registered item information table of the first user,
wherein the registered place information table of the first user comprises registered place information of at least one registered place registered by the first user in the item query system, and the registered place information of the each registered place comprises place information of the each registered place and sensor information corresponding to the each registered place;
the registered item information table of the first user comprises item registration information of at least one registered item registered by the first user in the item query system, and item registration information of each registered item of the at least one registered item comprises item information and a first place list of the each registered item, wherein the item information of the each registered item comprises at least one of an image and item description information of the each registered item; when the item information of the each registered item comprises the image of the each registered item, the item registration information of the each registered item also comprises feature information obtained by performing feature extraction on the image of the each registered item; and the first place list of the each registered item comprises place information of a second place where the each registered item is allowed to be left behind; and
the alarm-triggering item information corresponding to the first place is determined based on the registered place information table of the first user and each first place list in the registered item information table.

11. The method according to claim 7, further comprising:
obtaining a third image acquired by a second sensor, wherein the second sensor comprises a sensor corresponding to sensor information in the registered place information table of the first user;
searching for the first item based on item registration information of the first item and the third image, to determine a third place where the first item is located;
calling, according to a second cycle, a third sensor corresponding to the third place to perform image acquisition, and performing object detection and location tracking directed at the first item based on an acquired first image sequence and the item registration information of the first item, to obtain a first location tracking result;
in response to a change in a location of the first item, based on the first location tracking result, and according to a third cycle, calling the third sensor to perform image acquisition, and performing object detection and location tracking directed at the first item based on an acquired second image sequence and the item registration information of the first item, wherein the third cycle is less than the second cycle;
in response to that the first item is not detected in a latest image acquired by the third sensor, obtaining a third image sequence, wherein the third image sequence comprises at least one image that is acquired by the third sensor at an acquisition moment prior to that of the latest image; and
performing event analysis on the third image sequence using an analysis model, to obtain an event analysis result about the first item, and storing the event analysis result about the first item in a log file of the item query system.

12. The method according to claim 1, wherein the first event comprises receiving an item search request sent by a first user, wherein the item search request comprises the first item information; and
the determining first item information and first sensor information corresponding to a first event comprises:
in response to receiving the item search request sent by the first user, obtaining the first item information from the item search request, and obtaining sensor information corresponding to at least one registered place registered by the first user in the item query system to serve as the first sensor information.

13. The method according to claim 12, wherein the obtaining the sensor information corresponding to the at least one registered place registered by the first user in the item query system to serve as the first sensor information comprises:
in response to that the item search request comprises first place information, obtaining sensor information corresponding to the first place information to serve as the first sensor information; or
in response to that the item search request comprises no place information, obtaining the sensor information corresponding to the at least one registered place registered by the first user in the item query system to serve as the first sensor information.

14. The method according to claim 12, wherein the searching for a first item based on the first item information and the first image, to obtain a first search result comprises:
in response to that the first item information comprises a first item image and first item description information, performing feature extraction on the first item image to obtain first feature information; and performing object detection on the first image based on the first item description information, to obtain a fourth region proposal;
performing image feature extraction on the fourth region proposal to obtain fourth candidate feature information; and
determining, based on similarity between the fourth candidate feature information and the first feature information, whether the first image comprises the first item image corresponding to the first item information, to obtain the first search result, and outputting the first search result;
or
in response to that the first item information comprises first item description information but does not comprise a first item image, determining whether a registered item information table of the first user comprises feature information corresponding to the first item description information;
in response to that the registered item information table of the first user comprises second feature information corresponding to the first item description information, performing object detection on the first image based on the first item description information to obtain a fifth region proposal; performing image feature extraction on the fifth region proposal to obtain fifth candidate feature information; and determining, based on similarity between the fifth candidate feature information and the second feature information, whether the first image comprises a first item image corresponding to the first item information, to obtain the first search result, and outputting the first search result; and
in response to that the registered item information table of the first user does not comprise the feature information corresponding to the first item description information, performing object detection on the first image based on the first item description information; and determining, based on an obtained sixth region proposal, whether the first image comprises the first item image corresponding to the first item information, to obtain the first search result, and outputting the first search result;
or
in response to that the first item information comprises a first item image but does not comprise first item description information, performing feature extraction on the first item image to obtain first feature information;
performing object detection on the first image to obtain a seventh region proposal;
performing image feature extraction on the seventh region proposal to obtain seventh candidate feature information; and
determining, based on similarity between the seventh candidate feature information and the first feature information, whether the first image comprises the first item image corresponding to the first item information, to obtain the first search result, and outputting the first search result.

15. The method according to claim 14, further comprising: after determining whether the first image comprises the first item image corresponding to the first item information,
in response to that the first image does not comprise the first item image, obtaining at least one image from historical images acquired by the first sensor to serve as a fourth image; and
searching for the first item based on the first item information and the fourth image, to obtain the first search result.

16. The method according to claim 14, further comprising: in response to that the first search result indicates that the first item is not found, after outputting the first search result,
receiving query auxiliary information sent by the first user;
in response to that the query auxiliary information comprises second time information and fourth place information, obtaining a fourth sensor corresponding to the fourth place information, wherein at least one registered place registered by the first user in the item query system comprises a fourth place corresponding to the fourth place information;
obtaining at least one image corresponding to the second time information from images acquired by the fourth sensor to serve as a fifth image; and
searching for the first item based on the first item information and the fifth image, to obtain a second search result;
or
in response to that the query auxiliary information comprises second time information but comprises no place information, obtaining a first sensor corresponding to the at least one registered place registered by the first user in the item query system;
obtaining at least one image corresponding to the second time information from images acquired by the first sensor to serve as a sixth image; and
searching for the first item based on the first item information and the sixth image, to obtain a second search result;
or
in response to that the query auxiliary information comprises fourth place information but comprises no time information, obtaining a fourth sensor corresponding to the fourth place information;
obtaining a plurality of images acquired during a first historical time period from images acquired by the fourth sensor to serve as a seventh image; and
searching for the first item based on the first item information and the seventh image, to obtain a second search result.

17. The method according to claim 16, further comprising: after obtaining the second search result, in response to that the second search result indicates that the first item is not found,
querying whether a log file of the item query system comprises an event analysis result about the first item;
in response to that the log file comprises the event analysis result about the first item, determining whereabouts of the first item based on the event analysis result about the first item, to obtain a whereabouts determining result, and outputting the whereabouts determining result; and
in response to that the log file does not comprise the event analysis result about the first item, outputting the second search result.

18. The method according to claim 14, wherein the first search result indicates that the first item is found in the first image, the first search result comprises location information of the first item, and the location information of the first item comprises at least one of: the first image labeled with an item object bounding box and/or a location coordinate of the first item, or location description information of the first item,
wherein the method further comprises: after outputting the first search result,
in response to receiving first feedback information sent by the first user indicating that the first search result is correct, determining whether the registered item information table of the first user comprises item registration information of the first item;
in response to that the registered item information table of the first user comprises the item registration information of the first item, storing the first feature information in the item registration information of the first item as feature information of the first item, and storing the first search result in the item registration information of the first item as a positive sample; and
in response to that the registered item information table of the first user does not comprise the item registration information of the first item, adding the item registration information of the first item to the registered item information table of the first user with the first feature information being taken as the feature information of the first item and the first search result being taken as the positive sample, wherein the item registration information of the first item comprises the first item information, the feature information of the first item, and the positive sample;
or
in response to receiving second feedback information sent by the first user indicating that the first search result is wrong, determining whether the registered item information table of the first user comprises item registration information of the first item;
in response to that the registered item information table of the first user comprises the item registration information of the first item, storing the first feature information in the item registration information of the first item as feature information of the first item, and storing the first search result in the item registration information of the first item as a negative sample; and
in response to that the registered item information table of the first user does not comprise the item registration information of the first item, taking the first feature information as the feature information of the first item, taking the first search result as the negative sample, and adding the item registration information of the first item to the registered item information table of the first user, wherein the item registration information of the first item comprises the first item information, the feature information of the first item, and the negative sample.

19. A non-transitory computer readable storage medium, wherein the storage medium stores a computer program, and when executed, the computer program implements a method for searching for an item, which is applied to an item query system, the method comprising:
determining first item information and first sensor information corresponding to a first event, wherein the first sensor information comprises sensor information of a first sensor, the first sensor comprises a sensor corresponding to at least one registered place, and each registered place of the at least one registered place is a place registered in the item query system;
obtaining a first image acquired by the first sensor; and
searching for a first item based on the first item information and the first image, to obtain a first search result.

20. An electronic device, wherein the electronic device comprises:
a processor; and
a memory, configured to store processor-executable instructions,
wherein the processor is configured to read the executable instructions from the memory, and execute the instructions to implement a method for searching for an item, which is applied to an item query system, the method comprising:
determining first item information and first sensor information corresponding to a first event, wherein the first sensor information comprises sensor information of a first sensor, the first sensor comprises a sensor corresponding to at least one registered place, and each registered place of the at least one registered place is a place registered in the item query system;
obtaining a first image acquired by the first sensor; and
searching for a first item based on the first item information and the first image, to obtain a first search result.
